(19) United States
(12) Patent Application Publication
(10) Pub. No.: US 2021/0296955 A1
(43) Pub. Date: Sep. 23, 2021

(54) ELECTRIC WORK MACHINE

(71) Applicant: MAKITA CORPORATION, Anjo-shi (JP)

(72) Inventors: Takaya YAMADA, Anjo-shi (JP); Keisuke HANE, Anjo-shi (JP); Naoto SAKURAI, Anjo-shi (JP); Tatsuya MAEDA, Anjo-shi (JP)

(21) Appl. No.: 17/186,523

(22) Filed: Feb. 26, 2021

(30) Foreign Application Priority Data
Mar. 19, 2020 (JP) 2020-049787

(51) Int. Cl. H02K 3/28; H02K 7/14; H02K 3/12; H02K 3/34; H02K 1/16

(52) U.S. Cl. CPC H02K 3/28; H02K 7/145; H02K 1/16; H02K 3/34; H02K 3/12

(57) ABSTRACT

An electric work machine (1; 301), such as a power tool, includes a motor (8; 8B) having a rotor (19), which is rotatable relative to a stator (20; 20B). The stator includes: a stator core (32; 120) having teeth (37; 130); an insulator (33, 34; 122) supported by the stator core; coils (35, 112) wound through the insulator and around the teeth; a first wire (101; 149) that connects a first set of the coils; and a second wire (102; 149) that connects a second set of the coils. At least a portion of the first wire and at least a portion of the second wire are disposed in a same range in a circumferential direction of the stator. In at least a portion of that range, the first wire and the second wire are non-contactable and/or incapable of relative movement, whereby premature wire deterioration can be reduced.

### CRO S S-REFERENCE

The present application claims priority to Japanese patent application serial number 2020-049787 filed on Mar. 19, 2020, the contents of which are entirely incorporated fully herein by reference.

### TECHNICAL FIELD

The present disclosure relates to electric work machines that are driven using an electric motor having one or more winding wires.

### BACKGROUND ART

Power tools that comprise a brushless motor having a winding wire are known, e.g., from US 2017/0214292 and US 2019/0001452.

### SUMMARY OF THE INVENTION

Some brushless motors comprise a winding wire that forms: a first coil, which is wound around a first tooth, and a second coil, which is wound around a second tooth. A segment of the winding wire, also known as a crossover wire, electrically connects the first coil and the second coil. In such a brushless motor, two wires or two portions of the winding wire may be disposed such that they overlap. However, if such a brushless motor vibrates during operation, the two overlapping wires (or wire portions) may rub against one another, which accelerates deterioration of the wires (or wire portions). For example, if each wire or wire portion comprises a copper wire and an insulating coating (film) that covers the surface of the copper wire, when the two overlapping wires rub against one another, there is a possibility that both of the insulating coatings (films) will adversely peel off or wear through. In this case, the copper wires of the two wires might contact one another and cause a short circuit due to an insulation failure (layer short).

An object of the present disclosure is to disclose techniques for curtailing the premature deterioration of adjacent wires in an electric motor.

In one aspect of the present disclosure, an electric work machine may comprise: a motor that includes a stator and a rotor, which is rotatable relative to the stator. The stator may include: a stator core having a plurality of teeth; an (at least one) insulator supported by (or on) the stator core; and coils wound through the insulator and around the plurality of teeth. A first wire or first wire portion (wire segment) electrically connects a first set (two) of the coils and a second wire or second wire portion (wire segment) electrically connects a second set (a different two) of the coils. At least a portion of the first wire and at least a portion of the second wire are disposed in (along) a same range in a circumferential direction of the stator. In at least a portion of said range, the first wire and the second wire are disposed in a non-contactable manner and/or in a manner such that the first and second wires (wire portions) are incapable of moving relative to each other.

Thus, according to this aspect of the present disclosure, premature deterioration of adjacent wires in an electric motor can be curtailed.

### BRIEF DESCRIPTION OF THE DRAWINGS

FIG. 1 is a side view of a power tool according to a first embodiment of the present teachings.

FIG. 2 is an oblique view, viewed from the front, of a stator according to the first embodiment.

FIG. 3 is an oblique view, viewed from the rear, of the stator according to the first embodiment.

FIG. 4 is an exploded, oblique view, viewed from the front, of the stator according to the first embodiment.

FIG. 5 is an exploded, oblique view, viewed from the rear, of the stator according to the first embodiment.

FIG. 6 is an exploded, oblique view, viewed from the front, of a front insulator according to the first embodiment.

FIG. 7 is an exploded, oblique view, viewed from the rear, of the front insulator according to the first embodiment.

FIGS. 8A and 8B schematically show the front and the rear of the stator, respectively, according to the first embodiment.

FIG. 9 schematically shows the wiring state of coils according to the first embodiment.

FIG. 10 is a rear view of the stator according to the first embodiment.

FIG. 11 is a partial, enlarged view of the stator according to the first embodiment.

FIG. 12 is a partial, enlarged view of a stator according to a second embodiment.

FIG. 13 is an oblique view of a portion of a stator according to a third embodiment.

FIG. 14 is an oblique view of a portion of a stator according to a fourth embodiment.

FIG. 15 is an oblique view, viewed from the rear, of a stator according to a fifth embodiment.

FIG. 16 is a rear view of a stator according to a sixth embodiment.

FIG. 17 is an oblique view of an electric work machine according to a seventh embodiment.

FIG. 18 is an oblique view, viewed from the right, of a stator according to the seventh embodiment.

FIG. 19 is an exploded, oblique view, viewed from the right, of the stator according to the seventh embodiment.

FIG. 20 is a view that schematically shows the wiring state of the coils according to the seventh embodiment.

FIG. 21 is an oblique view of a terminal unit according to the seventh embodiment.

FIG. 22 is an enlarged view of a fusing terminal according to the seventh embodiment.

FIG. 23 is a side view of the stator according to the seventh embodiment.

FIG. 24 is an enlarged view of a portion of the stator according to the seventh embodiment.

FIG. 25 is an enlarged view of a portion of a stator according to an eighth embodiment.

FIG. 26 is an enlarged view of a portion of a stator according to a ninth embodiment.

### DETAILED DESCRIPTION OF THE INVENTION

Embodiments according to the present disclosure are explained below, with reference to the drawings, but the present disclosure is not limited to the embodiments. Structural elements of the embodiments explained below can be combined where appropriate. In addition, in some embodiments of the present disclosure, one or more of the structural elements may be omitted.

In the embodiments described below, positional relationships among parts are explained using the terms left, right, front, rear, up, and down. These terms indicate relative positions and directions, with the center of the electric work machine serving as a reference. The electric work machine comprises a motor, in particular an electric motor such as a brushless motor.

In the embodiments described below, the direction parallel to a rotational axis AX of the motor is referred to as the axial direction where appropriate, the radiating (radially-extending) direction of the rotational axis AX of the motor is referred to as the radial direction where appropriate, and the direction that goes around (encircles) the rotational axis AX of the motor is referred to as the circumferential direction or the rotational direction where appropriate. In addition, in the radial direction, a location that is near (proximal) to, as well as a direction that approaches, the rotational axis AX of the motor is referred to as inward in the radial direction where appropriate, and a location that is far (remote) from, as well as a direction that goes away, from the rotational axis AX of the motor is referred to as outward in the radial direction where appropriate.

### First Embodiment

### Electric Work Machine

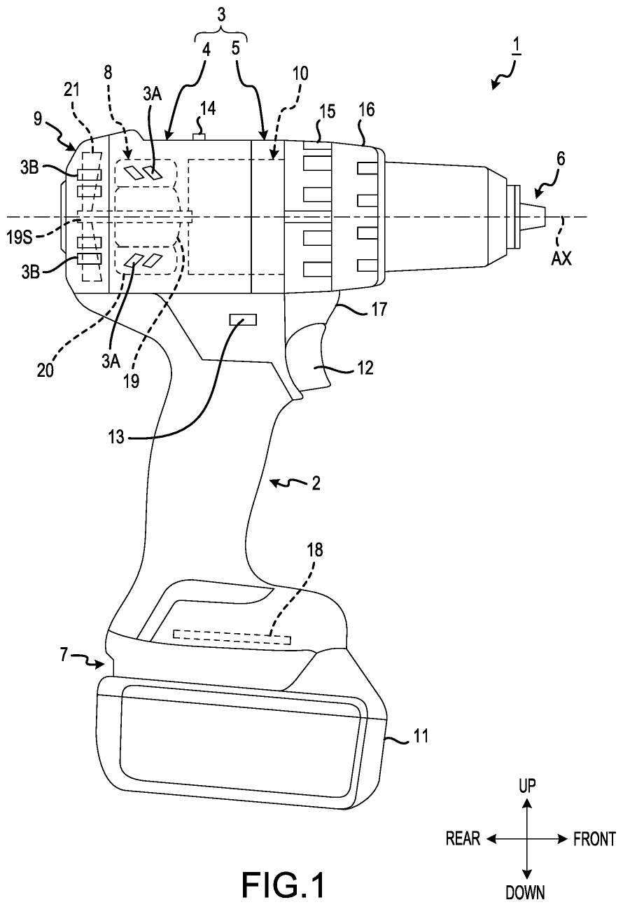

FIG. 1 is a side view of an electric work machine 1 according to the present embodiment. In the present embodiment, the electric work machine 1 is a hammer driver-drill, which is one type of power tool. As shown in FIG. 1, the electric work machine 1 comprises a grip housing 2, a main-body housing 3, an output shaft 6, and a battery-mounting part 7.

The grip housing 2 is gripped by a user. The grip housing 2 protrudes downward from a lower portion of the main-body housing 3. The grip housing 2 is made of synthetic resin.

The main-body housing 3 is disposed upward of the grip housing 2. The main-body housing 3 houses a motor 8 and a power-transmission mechanism 10. The main-body housing 3 comprises a motor housing 4 and a gear housing 5. The gear housing 5 is disposed forward of the motor housing 4. The output shaft 6 protrudes forward from the gear housing 5.

The motor housing 4 houses the motor 8. The motor housing 4 has a tube shape. The motor 8 is disposed in the interior space of the motor housing 4. The motor housing 4 is integral with the grip housing 2. The motor housing 4 is made of synthetic resin. Hereinafter, all references to “synthetic resin” are intended to also encompass and/or mean “polymer”. A rear cover 9 is disposed in a rear portion of the motor housing 4. The rear cover 9 covers an opening in the rear portion of the motor housing 4. The rear cover 9 is made of synthetic resin.

The motor housing 4 has air-suction ports 3A. The rear cover 9 has air-exhaust ports 3B. The air-exhaust ports 3B are provided rearward of the air-suction ports 3A. Each of the air-suction ports 3A connects the interior space and the exterior space of the main-body housing 3. Each of the air-exhaust ports 3B connects the interior space and the exterior space of the main-body housing 3. The air-suction ports 3A are provided on a left portion and on a right portion of the motor housing 4. The air-exhaust ports 3B are provided on a left portion and a right portion of the rear cover 9. A fan 21 is housed in the rear cover 9. When the fan 21 rotates, air outside of the main-body housing 3 flows into the interior space of the main-body housing 3 via the air-suction ports 3A. The air that has flowed into the interior space of the main-body housing 3 cools the motor 8. The air in the interior space of the main-body housing 3 then flows out of the main-body housing 3 via the air-exhaust ports 3B.

The gear housing 5 houses the power-transmission mechanism 10, which comprises a plurality of gears. The gear housing 5 has a tube shape. The power-transmission mechanism 10 is disposed in the interior space of the gear housing 5. The gear housing 5 is made of aluminum. The power-transmission mechanism 10 preferably comprises or is constituted by a speed-reducing (torque-increasing) mechanism, which may contain, e.g., a plurality of planetary gears.

A tool accessory is mountable on and/or in the output shaft 6. A tool accessory such as a drill bit is mounted on and/or in the output shaft 6. The output shaft 6 comprises a spindle, which rotates when driven by a rotational force generated by the motor 8, and a chuck, which detachably mounts the tool accessory on the output shaft 6.

A battery pack 11 is connected to the battery-mounting part 7. The battery-mounting part 7 is provided on a lower portion of the grip housing 2. The battery pack 11 is detachable from the battery-mounting part 7. The battery pack 11 comprises a secondary battery. In the embodiments, the battery pack 11 comprises one or more rechargeable lithium-ion battery cells. When mounted on the battery-mounting part 7, the battery pack 11 can supply electric power to the electric work machine 1.

The motor 8 generates a driving (rotational) force that causes the output shaft 6 to rotate. The motor 8 is driven by the electric power supplied from the battery pack 11. The power-transmission mechanism 10 transmits to the output shaft 6 the driving force generated by the motor 8. The output shaft 6 is rotated owing to the driving force transmitted from the motor 8 via the power-transmission mechanism 10.

The motor 8 is preferably a brushless motor. The motor 8 comprises a stator 20 and a rotor 19, which is rotatable relative to the stator 20. In the present embodiment, the motor 8 is an inner-rotor-type motor that comprises the stator 20, which has a tube shape, and the rotor 19, which is disposed inward of (in the interior of) the stator 20. The rotor 19 comprises a rotor shaft 19S, which extends in the axial direction. The rotor 19 is rotatable about the rotational axis AX. In the embodiments described herein, the axial direction and a front-rear direction coincide.

The fan 21 is fixed to the rotor shaft 19S. The fan 21 is disposed rearward of the stator 20. When the rotor shaft 19S rotates, the fan 21 also rotates.

The electric work machine 1 comprises a trigger switch 12, a forward/reverse-switch lever 13, a speed-change lever 14, a mode-change ring (or action mode changing ring) 15, a change ring (or adjusting ring) 16, a light 17, and a controller 18.

The trigger switch 12 is disposed on the grip housing 2. The trigger switch 12 protrudes forward from an upper portion of a front portion of the grip housing 2. The trigger switch 12 is manually operatable by the user. When the user grips the grip housing 2 with either their left or right hand, the user can manually operate (pull, squeeze, depress) the trigger switch 12 with their finger. When the trigger switch 12 is manually operated (e.g., pulled), electric power is supplied from the battery pack 11 to the motor 8, and thereby the motor 8 is driven. That is, by manually operating the trigger switch 12, the motor 8 is changed between a ‘driving’ state and a ‘stopped’ state.

The forward/reverse-switch lever 13 is provided on an upper portion of the grip housing 2. The forward/reverse-switch lever 13 is manually operable (laterally shiftable) by the user. By manually operating (shifting) the forward/reverse-switch lever 13, the rotational direction of the motor 8 can be changed. In other words, by manually operating the forward/reverse-switch lever 13, the user can change the rotational direction of the motor 8 from a forward-rotational direction to a reverse-rotational direction or vice versa. When the rotational direction of the motor 8 is changed, the rotational direction of the output shaft 6 is changed.

The speed-change lever 14 is provided on an upper portion of the main-body housing 3. The speed-change lever 14 is manually operable (shiftable) by the user. When the speed-change lever 14 is manually operated, the rotational speed of the output shaft 6 is changed. By manually operating the speed-change lever 14, the user can change the rotational speed of the output shaft 6 from a first speed to a second speed, which is higher than the first speed, or vice versa.

The mode-change ring (action mode change ring) 15 is disposed forward of the gear housing 5. The mode-change ring 15 is manually operable (rotatable) by the user. When the mode-change ring 15 is manually operated (rotated), the action mode of the electric work machine 1 is changed.

The action modes of the electric work machine 1 (here, a hammer driver-drill) include a hammer drilling mode (rotation with hammering), in which the output shaft 6 hammers in the front-rear direction, and non-hammer modes, in which the output shaft 6 does not hammer in the front-rear direction. The non-hammer modes include: a drilling mode, in which the driving force is transmitted to the output shaft 6 regardless of the rotational load that acts on the output shaft 6; and a screwdriving mode (rotation with clutch), in which the driving force transmitted to the output shaft 6 is cut off based on the rotational load (fastening torque) that acts on the output shaft 6.

The change ring 16 is disposed forward of the mode-change ring 15. The change ring 16 is manually operable (rotatable) by the user. In the screwdriving mode, a disengagement value, at which the driving force transmitted to the output shaft 6 is cut off or interrupted (i.e. the clutch begins to slip), is set by manually operating (rotating) the change ring 16. The disengagement value is a value that relates (corresponds) to the rotational load (fastening torque) that acts on the output shaft 6. When the rotational load (fastening torque) that acts on the output shaft 6 has reached the disengagement value, the driving force is no longer transmitted to the output shaft 6, i.e. the motor 8 may continue to rotate, but the rotational force is interrupted by the disengagement of the clutch.

The light 17 is provided on an upper portion of a front portion of the grip housing 2. The light 17 emits illumination light that illuminates forward of the electric work machine 1. The light 17 comprises, for example, a light-emitting diode (LED).

The controller 18 outputs control signals that control the electric work machine 1. The controller 18 controls the drive current supplied to the motor 8. The controller 18 is housed in the grip housing 2. The controller 18 is disposed in a lower portion of the interior space of the grip housing 2.

<Stator>

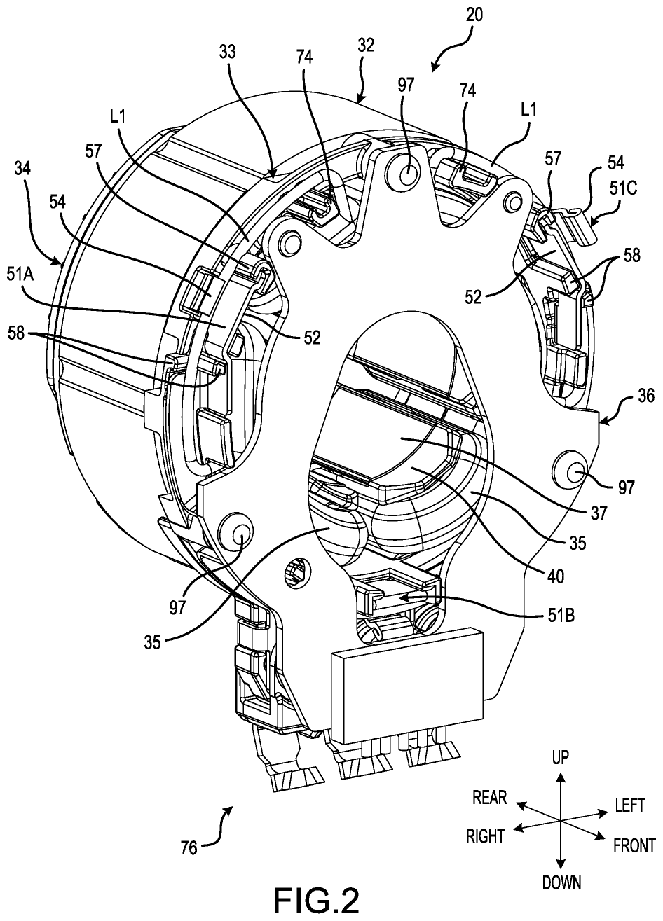

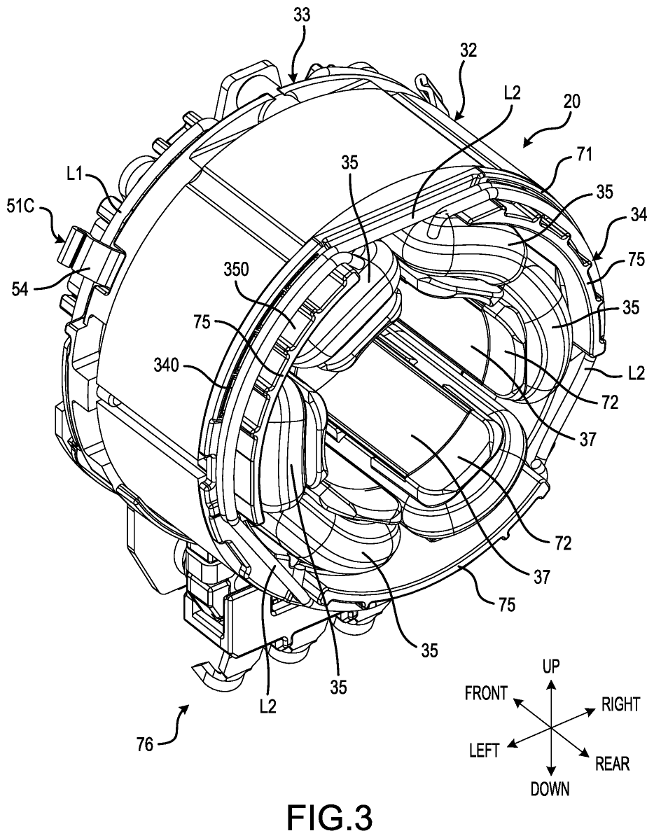

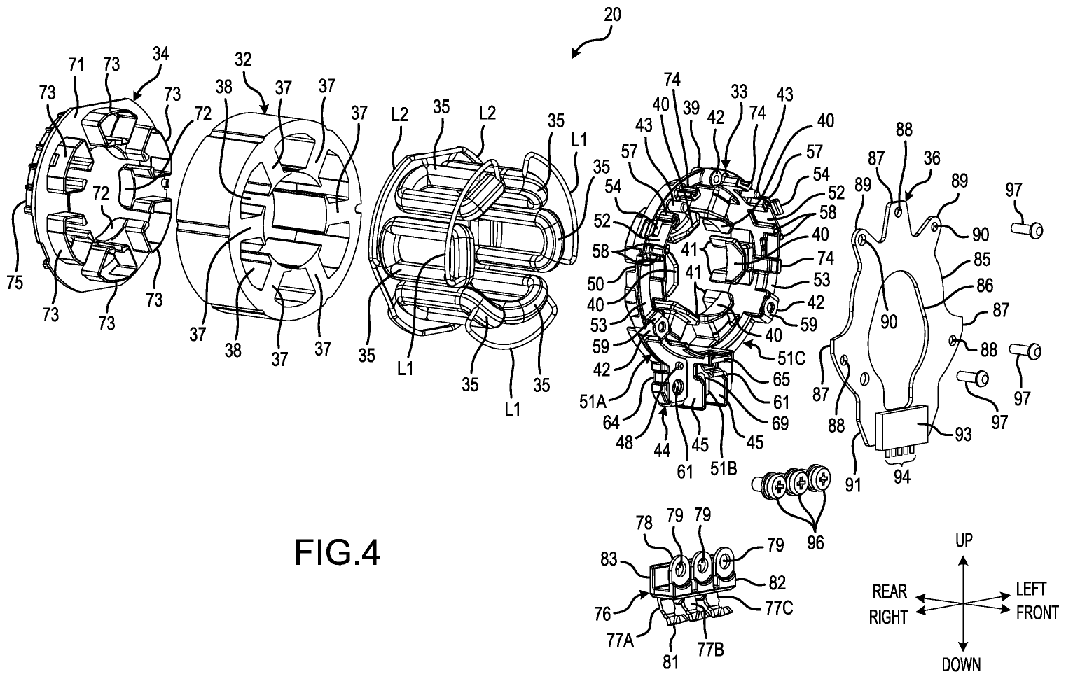

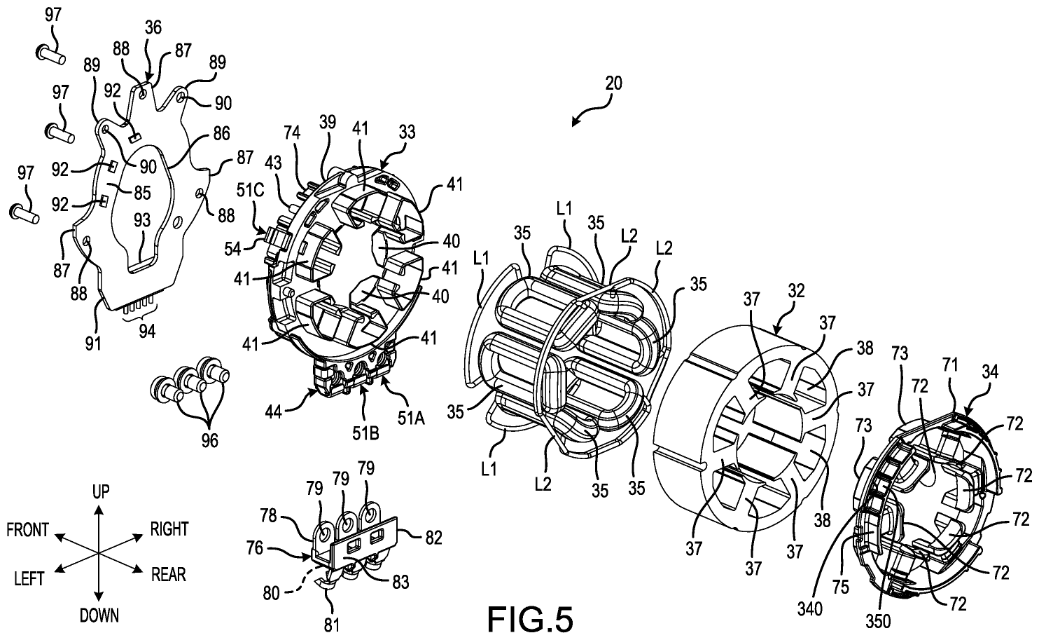

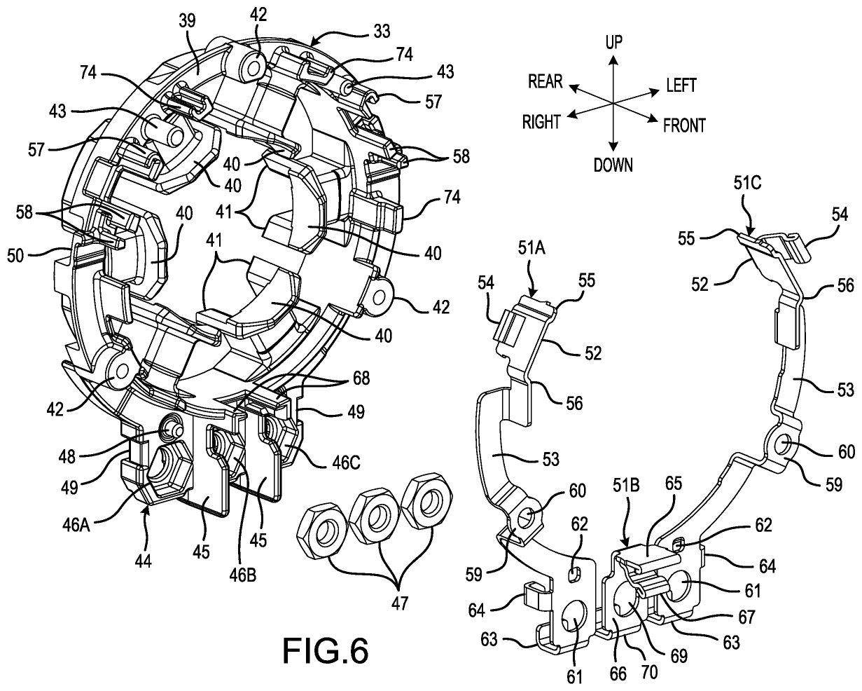

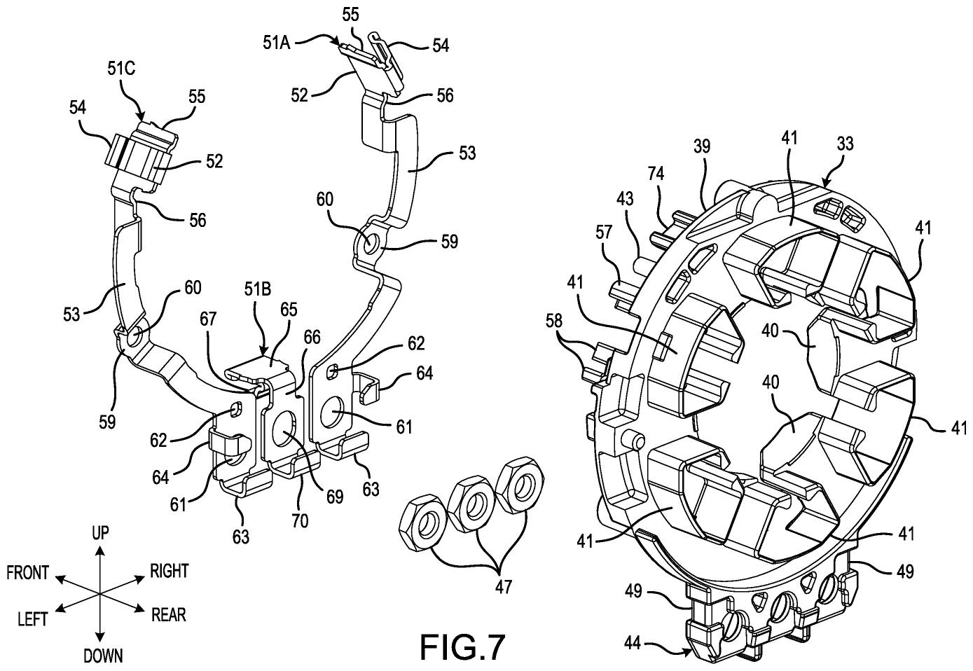

Next, the stator 20 according to the present embodiment will be explained. FIG. 2 is an oblique view, viewed from the front, of the stator 20 according to the present embodiment. FIG. 3 is an oblique view, viewed from the rear, of the stator 20 according to the present embodiment. FIG. 4 is an exploded, oblique view, viewed from the front, of the stator 20 according to the present embodiment. FIG. 5 is an exploded, oblique view, viewed from the rear, of the stator 20 according to the present embodiment. FIG. 6 is an exploded, oblique view, viewed from the front, of a front insulator 33 according to the present embodiment. FIG. 7 is an exploded, oblique view, viewed from the rear, of the front insulator 33 according to the present embodiment.

The stator 20 comprises a stator core 32, the front insulator 33, a rear insulator 34, coils 35, a sensor circuit board 36, fusing terminals 51A, 51B, 51C, and a terminal unit 76.

The stator core 32 comprises multiple steel sheets, which are laminated together. The stator core 32 has a tube shape overall. The stator core 32 comprises a plurality of teeth 37. In the present embodiment, six of the teeth 37 are provided. The teeth 37 protrude inward in the radial direction from an inner circumferential surface of the stator core 32. The teeth 37 are disposed equispaced in the circumferential direction. Slots (openings) 38 are formed between adjacent ones of the teeth 37.

The front insulator 33 and the rear insulator 34 are each supported by (on) the stator core 32. The front insulator 33 and the rear insulator 34 are each formed of synthetic resin. The front insulator 33 is disposed on a front portion of the stator core 32. The rear insulator 34 is disposed on a rear portion of the stator core 32.

The front insulator 33 comprises a ring part 39, a plurality of insulating ribs 40, a plurality of mating ribs 41, screw bosses 42, positioning pins 43, a coupling plate 44, positioning projections 48, grooves 49, and recessed parts (recesses) 50.

The ring part 39 functions as a base portion (base) of the front insulator 33. The outer diameter of the ring part 39 is at least substantially equal to the outer diameter of the stator core 32.

The insulating ribs 40 are provided on an inner surface of the ring part 39. The insulating ribs 40 protrude inward in the radial direction from the inner circumferential surface of the ring part 39. The insulating ribs 40 are disposed equispaced in the circumferential direction. In the present embodiment, six of the insulating ribs 40 are provided. When the front insulator 33 is supported by (attached to) the stator core 32, the insulating ribs 40 are respectively connected to front portions of the teeth 37.

The mating ribs 41 are provided on a rear surface of the ring part 39. The mating ribs 41 protrude rearward from the rear surface of the ring part 39. The mating ribs 41 are disposed equispaced in the circumferential direction. In the present embodiment, six of the mating ribs 41 are provided. The mating ribs 41 fit into the slots 38 from the front of the slots 38. The front insulator 33 and the stator core 32 are connected to one another by fitting the mating ribs 41 into the respective slots 38.

The screw bosses 42 are provided on a front surface of the ring part 39. Three of the screw bosses 42 are provided. The three screw bosses 42 are disposed equispaced in the circumferential direction. The screw bosses 42 are used to fix the sensor circuit board 36 to the front insulator 33 using screws 97.

The positioning pins 43 protrude forward from the front surface of the ring part 39. Two of the positioning pins 43 are provided. The positioning pins 43 are used to position the sensor circuit board 36 with respect to the front insulator 33.

The coupling plate 44 protrudes downward from a lower portion of the ring part 39. The coupling plate 44 is coupled to the terminal unit 76. Three coupling pieces 46A, 46B, 46C are provided on the coupling plate 44. The coupling pieces 46A, 46B, 46C are disposed along a left-right direction. The coupling pieces 46A, 46B, 46C are partitioned by partitioning ribs 45. A through hole, which passes through in the front-rear direction, is formed in each of the coupling pieces 46A, 46B, 46C. A nut 47 is disposed in each of the through holes. The nuts 47 are used to fix the coupling plate 44 to the terminal unit 76 using screws 96.

The positioning projections 48 are provided such that they protrude forward from a front surface of the coupling plate 44. Two of the positioning projections 48 are provided. The positioning projections 48 are used to position the fusing terminals 51A, 51C with respect to the front insulator 33.

The grooves 49 are respectively provided on a right surface and a left surface of the coupling plate 44. The grooves 49 are provided such that they extend in the front-rear direction. Transverse tabs 64 of the fusing terminals 51A, 51C, which are described below, are disposed in the grooves 49.

The recessed parts 50 are disposed on a right surface and a left surface of the ring part 39. In other words, recesses are defined on a right rear surface and a left rear surface of the ring part 39 The recessed parts 50 are used to position the front insulator 33 with respect to the motor housing 4.

The rear insulator 34 comprises a ring part 71, a plurality of insulating ribs 72, and a plurality of mating ribs 73.

The ring part 71 functions as a base portion of the rear insulator 34. The outer diameter of the ring part 71 is at least substantially equal to the outer diameter of the stator core 32.

The insulating ribs 72 are provided on an inner surface of the ring part 71. More specifically, the insulating ribs 72 protrude inward in the radial direction from the inner circumferential surface of the ring part 71. The insulating ribs 72 are disposed equispaced in the circumferential direction. In the present embodiment, six of the insulating ribs 72 are provided. In the state in which the rear insulator 34 is supported by (attached to) the stator core 32, the insulating ribs 72 are respectively connected to rear portions of the teeth 37.

The mating ribs 73 are provided on a front surface of the ring part 71. The mating ribs 73 protrude forward from the front surface of the ring part 71. The mating ribs 73 are disposed equispaced in the circumferential direction. In the present embodiment, six of the mating ribs 73 are provided. The mating ribs 73 respectively fit into the slots 38 from the rear of the slots 38. That is, the rear insulator 34 and the stator core 32 are connected to one another by fitting the mating ribs 73 into the respective slots 38.

The coils 35 are respectively wound around each of the teeth 37 and through (around) the front insulator 33 and the rear insulator 34. In the present embodiment, six of the coils 35 are provided. As described below, the six coils 35 are connected as a U phase, a V phase, and a W phase. A pair of the coils 35 is allocated to each phase, that is, to the U phase, the V phase, and the W phase.

The pair of the U-phase coils 35 is disposed such that the U-phase coils 35 oppose one another in the radial direction (i.e. diametrically oppose each other). The pair of the V-phase coils 35 is disposed such that the V-phase coils 35 oppose one another in the radial direction (i.e. diametrically oppose each other). The pair of the W-phase coils 35 is disposed such that the W-phase coils 35 oppose one another in the radial direction (i.e. diametrically oppose each other). In the circumferential direction, each of the V-phase coils 35 is disposed adjacent to one of the U-phase coils 35, and each of the W-phase coils 35 is disposed adjacent to one of the V-phase coils 35.

The U-phase coil 35 and the V-phase coil 35 that are adjacent to one another in the circumferential direction are connected via a crossover wire L1. The V-phase coil 35 and the W-phase coil 35 that are adjacent to one another in the circumferential direction are connected via a (another) crossover wire L1. The W-phase coil 35 and the U-phase coil 35 that are adjacent to one another in the circumferential direction are connected via a (another) crossover wire L1. The three above-noted crossover wires L1 may be three different segments of a single continuous wire (winding wire) 100 that is wound around the respective teeth 37 to form the coils 35. In such an embodiment, each “crossover wire” L1 should be understood as being an undivided wire segment (portion) of the wire 100. In the alternative, the three above-noted crossover wires L1 may be three discrete pieces of wire in an embodiment in which the coils 35 are respectively wound with discrete (severed) pieces of wire.

The crossover wires L1 are supported by the front insulator 33. In the present embodiment, the front insulator 33 comprises front-guide ribs 74, which guide the crossover wires L1. The front-guide ribs 74 protrude forward from the front surface of the ring part 39. The front-guide ribs 74 is provided spaced apart in the circumferential direction. At least a portion of each of the crossover wires L1 is disposed outward of its corresponding front-guide rib 74 in the radial direction. The crossover wires L1 are supported by the ring part 39 and the front-guide ribs 74.

The pair of the U-phase coils 35 is connected via a crossover wire L2. The pair of the V-phase coils 35 is connected via a (another) crossover wire L2. The pair of the W-phase coils 35 is connected via a (another) crossover wire L2. Similar to the crossover wires L1, the two above-noted crossover wires L2 may be two different segments of a single continuous wire (winding wire) 100 that is wound around the respective teeth 37 to form the coils 35. In such an embodiment, each “crossover wire” L2 should be understood as being an undivided wire segment (portion) of the wire 100. In the alternative, the two above-noted crossover wires L2 may be two discrete pieces of wire in an embodiment in which the coils 35 are respectively wound with discrete (severed) pieces of wire.

The crossover wires L2 are supported by the rear insulator 34. In the present embodiment, the rear insulator 34 comprises rear-guide ribs 75, which respectively guide the crossover wires L2. The rear-guide ribs 75 protrude rearward from a rear surface of the ring part 71. The rear-guide ribs 75 are provided spaced apart in the circumferential direction. At least a portion of each of the crossover wires L2 is disposed outward of its corresponding rear-guide rib 75 in the radial direction. The crossover wires L2 are supported by the ring part 71 and the rear-guide ribs 75.

In the present embodiment, three of the rear-guide ribs 75 are provided spaced apart in the circumferential direction. Each of the rear-guide ribs 75 has an arcuate shape in a plane that is orthogonal to the rotational axis AX. At least a portion of each of the crossover wires L2 is supported by an outer-circumferential surface 350 of its corresponding rear-guide rib 75. At least a portion of each of the crossover wires L2 is supported by a corresponding support surface 340, which is a portion of the rear surface of the ring part 71.

The sensor circuit board 36 is mounted on the front insulator 33. The sensor circuit board 36 comprises a disk part 85, a plurality of rotation-detection devices 92 supported by (on) the disk part 85, and a connecting part 93 supported by (on) the disk part 85.

A through hole 86 is formed in a center portion of the disk part 85. Three screw-stop pieces 87 and two positioning pieces 89 are provided on circumferential-edge portions of the disk part 85. The screw-stop pieces 87 and the positioning pieces 89 protrude outward in the radial direction from circumferential-edge portions of the disk part 85. A through hole 88 is formed in each of the three screw-stop pieces 87. A through hole 90 is formed in each of the two positioning pieces 89. In addition, a connecting piece 91 is provided on a lower portion of the disk part 85. The connecting piece 91 protrudes downward from a lower portion of the disk part 85.

The rotation-detection devices 92 detect the rotation of the rotor 19. In the present embodiment, three of the rotation-detection devices 92 are provided. The rotation-detection devices 92 are disposed on a rear surface of the disk part 85.

The connecting part 93 is disposed on a front surface of the connecting piece 91. The rotation-detection devices 92 are connected to signal lines 94 via the connecting part 93. In the present embodiment, six of the signal lines 94 are provided. Detection signals of the rotation-detection devices 92 are output to the controller 18 via the connecting part 93 and the signal lines 94.

The fusing terminals 51A, 51B, 51C are connected to the coils 35 via the crossover wires L1. The fusing terminals 51A, 51B, 51C are provided on the front insulator 33. The coils 35 are connected to power-supply lines (not shown) via the crossover wires L1, the fusing terminals 51A, 51B, 51C, and the terminal unit 76. The drive current from the battery pack 11 is supplied to the coils 35 via the controller 18, the power-supply lines, the terminal unit 76, the fusing terminals 51A, 51B, 51C, and the crossover wires L1.

The fusing terminal 51A is disposed rightward of the fusing terminal 51B. The fusing terminal 51C is disposed leftward of the fusing terminal 51B.

As can be seen, e.g., in FIG. 7, each of the fusing terminals 51A, 51C comprises: a fusing part 52, which is electrically connected (fused) to the corresponding crossover wire L1; an extension part 53, which extends downward from the fusing part 52; a lower tab 63, which is provided on a lower portion of the extension part 53; and a transverse tab 64, which is provided on a lower portion of the extension part 53.

The fusing parts 52 are disposed forward of the ring part 39. Each of the fusing parts 52 is connected to a sandwiching piece (clamping piece) 54 via a folded portion. In addition, support pieces 55 are respectively connected to one end part of the fusing parts 52 in the circumferential direction, and are respectively connected to the other end part of the fusing parts 52 in the circumferential direction. The fusing parts 52 are linked to the extension parts 53 via the support pieces 56. The sandwiching pieces 54 are disposed outward of the fusing parts 52 in the radial direction. Rear-end portions of the fusing parts 52 and rear-end portions of the sandwiching pieces 54 are connected via the folded portions. In each of the fusing terminals 51A, 51C, the crossover wire L1 is sandwiched (clamped) between the fusing part 52 and the sandwiching piece 54.

The extension parts 53 are disposed forward of the ring part 39. The extension parts 53 are linked to the fusing parts 52 via the support pieces 56. Each of the extension parts 53 has an arcuate shape. A bent part 59 is provided along a portion of each of the extension parts 53. The bent parts 59 are bent such that they protrude forward. A through hole 60 is provided in each of the bent parts 59. The bent parts 59 oppose front surfaces of the screw bosses 42. Lower portions of the extension parts 53 oppose front surfaces of the coupling pieces 46A, 46C.

The support pieces 55 are held by retaining projections 57, which are provided on the ring part 39. The support pieces 56 are held by sandwiching projections 58, which are also provided on the ring part 39.

At least a portion of each of the lower tabs 63 is disposed such that it opposes a lower surface of the coupling pieces 46A, 46C, respectively. In addition, at least a portion of each the lower tab 63 is disposed such that it opposes a rear surface of the coupling pieces 46A, 46C, respectively. That is, the lower tabs 63 are hooked onto the coupling pieces 46A, 46C.

At least a portion of each of the transverse tabs 64 is disposed in one of the grooves 49 of the coupling plate 44. At least a portion of each the transverse tabs 64 is disposed such that it opposes the rear surface of the coupling pieces 46A, 46C, respectively. That is, the transverse tabs 64 are hooked onto the coupling pieces 46A, 46C.

The fusing terminal 51B comprises: a fusing part 65, which is electrically connected (fused) to one of the crossover wires L1; an extension part 66, which extends downward from the fusing part 65; and a lower tab 70, which is connected to a lower portion of the extension part 66.

The fusing part 65 is disposed forward of the ring part 39. The fusing part 65 is connected to a sandwiching piece (clamping piece) 67 via a folded portion. The sandwiching piece 67 is disposed outward of the fusing part 65 in the radial direction. A rear-end portion of the fusing part 65 and a rear-end portion of the sandwiching piece 67 are connected via the folded portion. In the fusing terminal 51B, one of the crossover wires L1 is sandwiched between the fusing part 65 and the sandwiching piece 67.

The extension part 66 is disposed forward of the ring part 39. The extension part 66 opposes a front surface of the coupling piece 46B.

The fusing part 65 is retained by retaining parts 68, which are provided on the ring part 39.

At least a portion of the lower tab 70 is disposed such that it opposes a lower surface of the coupling piece 46B. In addition, at least a portion of the lower tab 70 is disposed such that it opposes a rear surface of the coupling piece 46B. That is, the lower tab 70 is hooked onto the coupling piece 46B.

Through holes 61, in which the screws 96 are disposed, are provided in lower portions of the extension parts 53. In addition, square holes 62, in which the positioning projections 48 are disposed, are provided in lower portions of the extension parts 53. A through hole 69, in which one of the screws 96 is disposed, is provided in the extension part 66.

Referring now to FIGS. 4-6, the terminal unit 76 is coupled to the coupling plate 44 by the screws 96. The power-supply lines (not shown) are connected to the fusing terminals 51A, 51B, 51C via the terminal unit 76.

The terminal unit 76 comprises three lead-wire-side terminals 77A, 77B, 77C, which are disposed along the left-right direction. The three lead-wire-side terminals 77A, 77B, 77C respectively oppose the three fusing terminals 51A, 51B, 51C. The three lead-wire-side terminals 77A, 77B, 77C are formed integrally by (as) a resin (polymer) part 82.

Each of the lead-wire-side terminals 77A, 77B, 77C has a tip part 78, an intermediate part 80, and a base-end part 81. The intermediate part 80 extends in the front-rear direction. The tip part 78 extends upward from a front-end portion of the intermediate part 80. A through hole 79 is formed in the tip part 78. The base-end part 81 extends downward from a rear-end portion of the intermediate part 80. The three power-supply lines are respectively connected to the three base-end parts 81 by soldering or welding.

The resin part 82 is provided such that it couples the intermediate parts 80 of the lead-wire-side terminals 77A, 77B, 77C. The resin part 82 comprises a receiving piece 83, and the coupling plate 44 is sandwiched between the receiving piece 83 and the tip parts 78. The extension parts 53, 66 of the fusing terminals 51A, 51B, 51C and the coupling plate 44 are disposed between the tip parts 78 and the receiving piece 83.

Next, a method of assembling the stator 20 will be explained. The stator core 32 and the front insulator 33 are connected by fitting the mating ribs 41 into the respective slots 38 from the front of the stator core 32. The stator core 32 and the rear insulator 34 are connected by fitting the mating ribs 73 into the respective slots 38 from the rear of the stator core 32. The coils 35 are wound around each of the teeth 37 and through (around) the front insulator 33 and the rear insulator 34.

In the front insulator 33, the nuts 47 are disposed in the through holes of the coupling pieces 46A, 46B, 46C, one nut 47 in each of the through holes.

The support pieces 55 of the fusing terminals 51A, 51C are held by the retaining projections 57, and the support pieces 56 are held by the sandwiching projections 58. In addition, the positioning projections 48 are inserted into the square holes 62, and thereby the bent parts 59 of the extension parts 53 and the screw bosses 42 are positioned relative to each other. In addition, the lower tabs 63 and the transverse tabs 64 are hooked onto the coupling pieces 46A, 46C. Thereby, the through holes 60 and the screw holes of the screw bosses 42 coincide, and the through holes 61 and the nuts 47 coincide.

In addition, the fusing part 65 of the center fusing terminal 51B is held by the retaining parts 68, and the lower tab 70 is hooked onto the coupling piece 46B. Thereby, the through hole 69 and the corresponding nut 47 coincide.

Next, the crossover wires L1 and the fusing terminals 51A, 51B, 51C are respectively connected. In the fusing terminals 51A, 51C, the crossover wires L1 are respectively disposed between the fusing parts 52 and the sandwiching pieces 54. The crossover wires L1 are respectively fused by (to) the fusing parts 52. In addition, in the fusing terminal 51B, the crossover wire L1 is disposed between the fusing part 65 and the sandwiching piece 67. The crossover wire L1 is fused by (to) the fusing part 65.

Next, the terminal unit 76 and the coupling plate 44 are fixed to one another. When the coupling plate 44 and the extension parts 53, 66 are disposed between the tip parts 78 of the lead-wire-side terminals 77A, 77B, 77C and the receiving piece 83, the through holes 79, the through holes 61, 69, and the nuts 47 coincide. In the state in which the through holes 79, the through holes 61, 69, and the nuts 47 have been made to coincide, the screws 96 are joined to (screwed into) the nuts 47. Thereby, the terminal unit 76 and the coupling plates 44 are fixed to one another, and the lead-wire-side terminals 77A, 77B, 77C and the fusing terminals 51A, 51B, 51C are electrically connected to one another.

Next, the sensor circuit board 36 and the front insulator 33 are fixed to one another. When the positioning pins 43 are respectively inserted into the through holes 90, the sensor circuit board 36 and the front insulator 33 are positioned relative to each other.

Furthermore, when the positioning pins 43 are inserted into the through holes 90, the through holes 88 and the screw bosses 42 coincide. In the state in which the through holes 88 and the screw bosses 42 have been made to coincide, the screws 97 are joined to (screwed into) the screw holes of the screw bosses 42. Thereby, the sensor circuit board 36 and the front insulator 33 are fixed to one another. The bent parts 59 of the fusing terminals 51A, 51C are sandwiched between the screw-stop pieces 87 and the screw bosses 42.

<Coils>

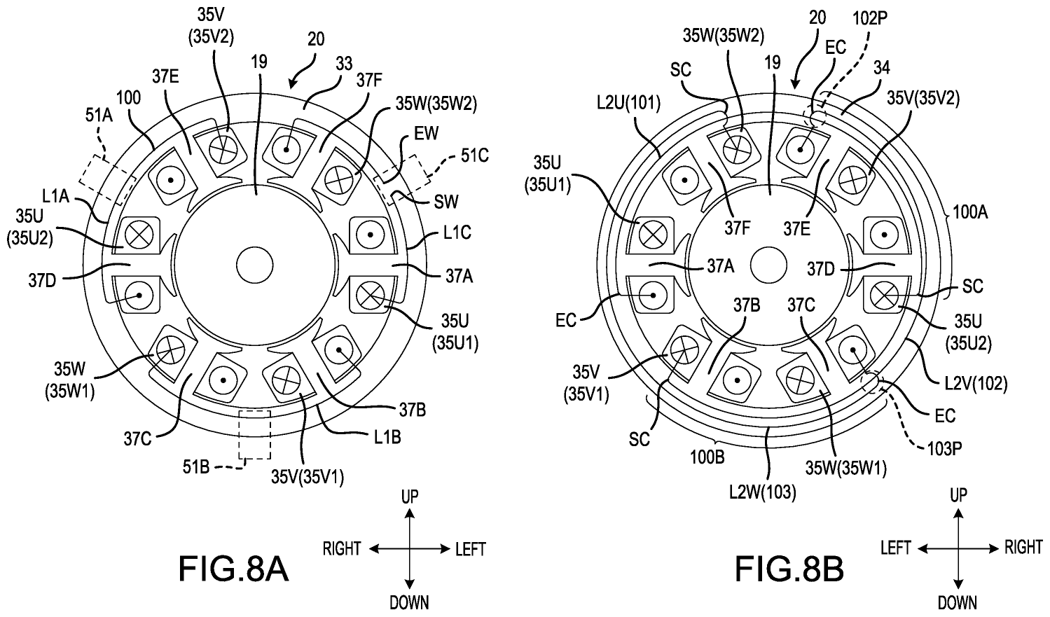

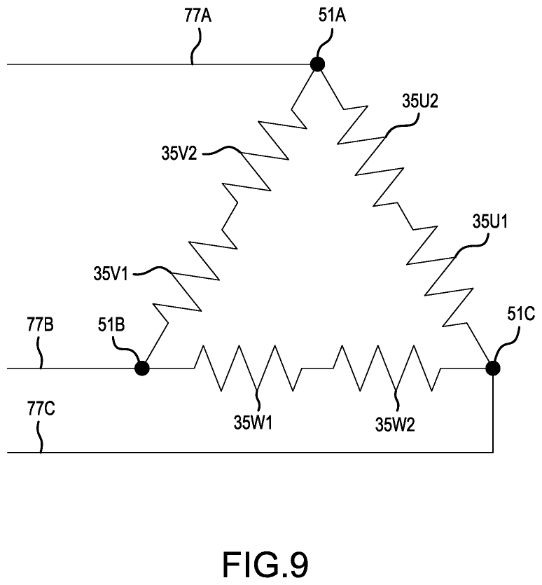

FIGS. 8A and 8B schematically show the stator 20 according to the present embodiment. More specifically, FIG. 8A corresponds to a view in which the stator 20 is viewed from the front (from the front insulator 33 side). FIG. 8B corresponds to a view in which the stator 20 is viewed from the rear (from the rear insulator 34 side). FIG. 9 schematically shows the wiring state of the coils 35 according to the present embodiment.

As shown in FIGS. 8A, 8B and 9, the six coils 35 are connected as the U (U-V) phase, the V (V-W) phase, and the W (W-U) phase. A pair of the coils 35 is allocated to each phase, that is, to the U phase, the V phase, and the W phase.

That is, the six coils 35 include a (first) pair of U-phase coils 35U allocated to the U phase, a (second) pair of V-phase coils 35V allocated to the V phase, and a (third) pair of W-phase coils 35W allocated to the W phase.

A U-phase coil 35U1 and a U-phase coil 35U2, which constitute a (the first) pair, are disposed such that they oppose one another in the radial direction; i.e. they diametrically oppose each other. A V-phase coil 35V1 and a V-phase coil 35V2, which constitute a (the second) pair, are disposed such that they oppose one another in the radial direction; i.e. they diametrically oppose each other. A W-phase coil 35W1 and a W-phase coil 35W2, which constitute a (the third) pair, are disposed such that they oppose one another in the radial direction; i.e. they diametrically oppose each other. In the circumferential direction, the V-phase coil 35V1 is disposed next to the U-phase coil 35U1, the W-phase coil 35W1 is disposed next to the V-phase coil 35V1, the U-phase coil 35U2 is disposed next to the W-phase coil 35W1, the V-phase coil 35V2 is disposed next to the U-phase coil 35U2, and the W-phase coil 35W2 is disposed next to the V-phase coil 35V2.

The pair of U-phase coils 35U is connected via crossover wire L2U. The pair of V-phase coils 35V is connected via crossover wire L2V. The pair of W-phase coils 35W is connected via crossover wire L2W. The crossover wire L2U, the crossover wire L2V, and the crossover wire L2W are supported by (on) the rear insulator 34.

The fusing terminal 51A is connected to crossover wire L1A that connects the U-phase coil 35U2 and the V-phase coil 35V2, which are adjacent to one another in the circumferential direction. The fusing terminal 51B is connected to crossover wire L1B that connects the V-phase coil 35V1 and the W-phase coil 35W1, which are adjacent to one another in the circumferential direction. The fusing terminal 51C is connected to crossover wire L1C that connects the W-phase coil 35W2 and the U-phase coil 35U1, which are adjacent to one another in the circumferential direction. The crossover wire L1A, the crossover wire L1B, and the crossover wire L1C are supported by (on) the front insulator 33.

The plurality of coils 35 is formed by winding a single continuous piece (length) of wire 100. The wire 100 comprises a copper wire and an insulating film (coating), which covers the surface of the copper wire. A polyester-resin film (coating) and a polyamide-resin film (coating) are illustrative examples of the insulating film (coating).

As shown in FIG. 8A, the winding of the wire 100 around a first tooth 37A is begun from a winding-start portion SW. The U-phase coil 35U1 is formed by winding the wire 100 around the first tooth 37A.

After the wire 100 has been wound around the first tooth 37A and thus the U-phase coil 35U1 has been formed on the first tooth 37A, the portion (segment) of the wire 100, which serves as the crossover wire L2U, is pulled around the rear insulator 34. The crossover wire L2U is pulled around from the first tooth 37A toward a fourth tooth 37D, which opposes the first tooth 37A. After the crossover wire L2U has been pulled around, the winding of the wire 100 around the fourth tooth 37D is begun. The U-phase coil 35U2 is formed by winding the wire around the fourth tooth 37D.

After the wire 100 has been wound around the fourth tooth 37D and thus the U-phase coil 35U2 has been formed on the fourth tooth 37D, the portion (segment) of the wire 100, which serves as the crossover wire L1A, is pulled around the front insulator 33. The crossover wire L1A is pulled around from the fourth tooth 37D toward a fifth tooth 37E, which is adjacent to the fourth tooth 37D. After the crossover wire L1A has been pulled around, the winding of the wire 100 around the fifth tooth 37E is begun. The V-phase coil 35V2 is formed by winding the wire 100 around the fifth tooth 37E.

After the wire 100 has been wound around the fifth tooth 37E and thus the V-phase coil 35V2 has been formed on the fifth tooth 37E, the portion (segment) of the wire 100, which serves as the crossover wire L2V, is pulled around the rear insulator 34. The crossover wire L2V is pulled around from the fifth tooth 37E toward a second tooth 37B, which opposes the fifth tooth 37E. After the crossover wire L2V has been pulled around, the winding of the wire 100 around the second tooth 37B is begun The V-phase coil 35V1 is formed by winding the wire 100 around the second tooth 37B.

After the wire 100 has been wound around the second tooth 37B and thus the V-phase coil 35V1 has been formed on the second tooth 37B, the portion (segment) of the wire 100, which serves as the crossover wire LIB, is pulled around the front insulator 33. The crossover wire L1B is pulled around from the second tooth 37B toward a third tooth 37C, which is adjacent to the second tooth 37B. After the crossover wire L1B has been pulled around, the winding of the wire 100 around the third tooth 37C is begun. The W-phase coil 35W1 is formed by winding the wire 100 around the third tooth 37C.

After the wire 100 has been wound around the third tooth 37C and thus the W-phase coil 35W1 has been formed on the third tooth 37C, the portion (segment) of the wire 100, which serves as the crossover wire L2W, is pulled around the rear insulator 34. The crossover wire L2W is pulled around from the third tooth 37C toward a sixth tooth 37F, which opposes the third tooth 37C. After the crossover wire L2W has been pulled around, the winding of the wire 100 around the sixth tooth 37F is begun. The W-phase coil 35W2 is formed by winding the wire 100 around the sixth tooth 37F.

After the wire 100 has been wound around the sixth tooth 37F and thus the W-phase coil 35W2 has been formed on the sixth tooth 37F, the portion (segment) of the wire 100, which serves as the crossover wire L1C, is pulled around the front insulator 33 from the sixth tooth 37F toward the first tooth 37A, which is adjacent to the sixth tooth 37F. The wire 100 that has been pulled around from the sixth tooth 37F toward the first tooth 37A becomes a winding-end portion EW.

As shown in FIG. 9, the pair of U-phase coils 35U (35U1, 35U2), the pair of V-phase coils 35V (35V1, 35V2), and the pair of W-phase coils 35W (35W1, 35W2) are wired in a delta configuration.

When a U-phase drive current is input to the fusing terminal 51A and thus the U-phase coil 35U2 of the pair of U-phase coils 35U is excited to the N pole, the other U-phase coil 35U1 of the pair of U-phase coils 35U is excited to the S pole. The V-phase coil 35V2 is excited to the S pole, and the V-phase coil 35V1 is excited to the N pole.

When a V-phase drive current is input to the fusing terminal 51B and thus the V-phase coil 35V1 of the pair of V-phase coils 35V is excited to the N pole, the other V-phase coil 35V2 of the pair of V-phase coils 35V is excited to the S pole. The W-phase coil 35W1 is excited to the S pole, and the W-phase coil 35W2 is excited to the N pole.

When a W-phase drive current is input to the fusing terminal 51C and thus the W-phase coil 35W2 of the pair of W-phase coils 35W is excited to the N pole, the other W-phase coil 35U1 of the pair of W-phase coils 35W is excited to the S pole. The U-phase coil 35U1 is excited to the S pole, and the U-phase coil 35U2 is excited to the N pole.

As described above, the coils 35 are formed by winding the single, continuous (undivided) wire 100 around all of the teeth 37. In the explanation below, the portion (segment) of the wire 100 that forms the crossover wire L2U is referred to as a first wire 101 where appropriate, the portion (segment) of the wire 100 that forms the crossover wire L2V is referred to as a second wire 102 where appropriate, and the portion (segment) of the wire 100 that forms the crossover wire L2W is referred to as a third wire 103 where appropriate.

The first wire 101 electrically connects the set (a first set) of the U-phase coils 35U that constitute the U phase. The second wire 102 electrically connects the set (a second set) of the V-phase coils 35V that constitute the V phase. The third wire 103 electrically connects the set (a third set) of the W-phase coils 35W that constitute the W phase.

When the wire 100 has been wound around the first tooth 37A, the portion (segment) of the wire 100, which serves as the crossover wire L2U, is pulled around the rear insulator 34 to the fourth tooth 37D and begins to be wound around the fourth tooth 37D. Within the first wire 101 that forms the crossover wire L2U, the end part that is close to the first tooth 37A will be called a winding-end portion EC of the first wire 101, and the end part that is close to the fourth tooth 37D will be called a winding-start portion SC of the first wire 101.

When the wire 100 has been wound around the fifth tooth 37E, the portion (segment) of the wire 100, which serves as the crossover wire L2V, is pulled around the rear insulator 34 to the second tooth 37B and begins to be wound around the second tooth 37B. Within the second wire 102 that forms the crossover wire L2V, the end part that is close to the fifth tooth 37E will be called the winding-end portion EC of the second wire 102, and the end part that is close to the second tooth 37B will be called the winding-start portion SC of the second wire 102.

When the wire 100 has been wound around the third tooth 37C, the portion (segment) of the wire 100, which serves as the crossover wire L2W, is pulled around the rear insulator 34 to the sixth tooth 37F and begins to be wound around the sixth tooth 37F. Within the third wire 103 that forms the crossover wire L2W, the end part that is close to the third tooth 37C will be called the winding-end portion EC of the third wire 103, and the end part that is close to the sixth tooth 37F will be called the winding-start portion SC of the third wire 103.

As can be seen in FIG. 8B, at least a portion of the first wire 101 and at least a portion of the second wire 102 are disposed in a same range 100A in the circumferential direction of the stator 20. The range 100A is defined on the rear insulator 34. In other words, at least a portion of the first wire 101 and at least a portion of the second wire 102 overlap one another in the range 100A of the rear insulator 34. In the range 100A, the second wire 102 is disposed such that it covers the first wire 101. The first wire 101 is supported (directly) by the rear insulator 34, and the second wire 102 is supported (indirectly) by the rear insulator 34 via the first wire 101.

In the present embodiment, the range 100A is defined such that it includes the fifth tooth 37E and the fourth tooth 37D in the circumferential direction.

At least a portion of the second wire 102 and at least a portion of the third wire 103 are disposed in a same range 100B in the circumferential direction of the stator 20. The range 100B is defined on the rear insulator 34. In other words, at least a portion of the second wire 102 and at least a portion of the third wire 103 overlap one another in the range 100B of the rear insulator 34. In the range 100B, the third wire 103 is disposed such that it covers the second wire 102. The second wire 102 is supported (directly) by the rear insulator 34, and the third wire 103 is supported (indirectly) by the rear insulator 34 via the second wire 102.

In the present embodiment, the range 100B is defined such that it includes the third tooth 37C and the second tooth 37B in the circumferential direction.

In at least a portion of the range 100A, the first wire 101 and the second wire 102 are disposed in a non-contactable manner. In at least a portion of the range 100B, the second wire 102 and the third wire 103 are disposed in a non-contactable manner.

In at least a portion of the range 100A, the first wire 101 and the second wire 102 are disposed in a manner incapable of relative movement, i.e. such that the first wire 101 is not movable relative to the second wire 102. In at least a portion of the range 100B, the second wire 102 and the third wire 103 are disposed in a manner incapable of relative movement, i.e. such that the second wire 102 is not movable relative to the third wire 103.

In the range 100A, the first wire 101 and a specified portion 102P of the second wire 102 are disposed in a non-contactable manner. In the range 100A, the first wire 101 and the specified portion 102P of the second wire 102 are disposed in a manner incapable of relative movement.

In the range 100B, the second wire 102 and a specified portion 103P of the third wire 103 are disposed in a non-contactable manner. In the range 100B, the second wire 102 and the specified portion 103P of the third wire 103 are disposed in a manner incapable of relative movement.

The specified portion 102P of the second wire 102 includes the winding-end portion EC of the second wire 102, which is disposed such that it covers the first wire 101. The specified portion 103P of the third wire 103 includes the winding-end portion EC of the third wire 103, which is disposed such that it covers the second wire 102.

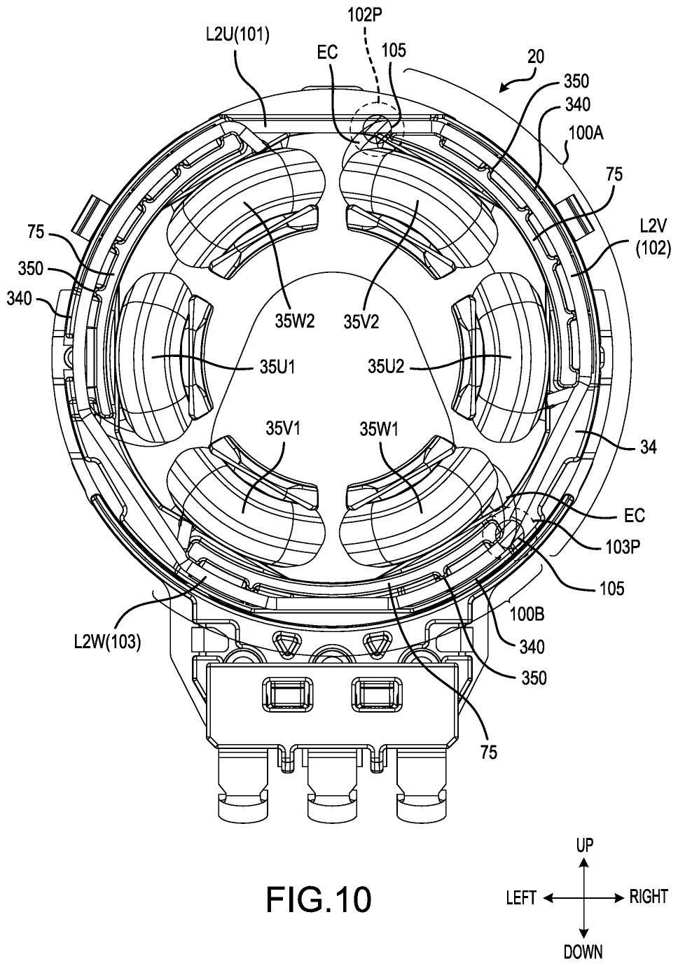

FIG. 10 is a rear view of the stator 20 according to the present embodiment. As shown in FIG. 10, a bonding agent 105 fixes the first wire 101 and the specified portion 102P of the second wire 102 to the rear insulator 34 of the stator 20 in the state in which the first wire 101 and the specified portion 102P of the second wire 102 are spaced apart. In addition, a bonding agent 105 also fixes the second wire 102 and the specified portion 103P of the third wire 103 to the rear insulator 34 of the stator 20 in the state in which the second wire 102 and the specified portion 103P of the third wire 103 are spaced apart. That is, the bonding agent 105 is applied to the first wire 101 and the second wire 102 such that the first wire 101 and the winding-end portion EC of the second wire 102, which is disposed such that it covers the first wire 101, are spaced apart. The bonding agent 105 is applied to the second wire 102 and the third wire 103 such that the second wire 102 and the winding-end portion EC of the third wire 103, which is disposed such that it covers the second wire 102, are spaced apart.

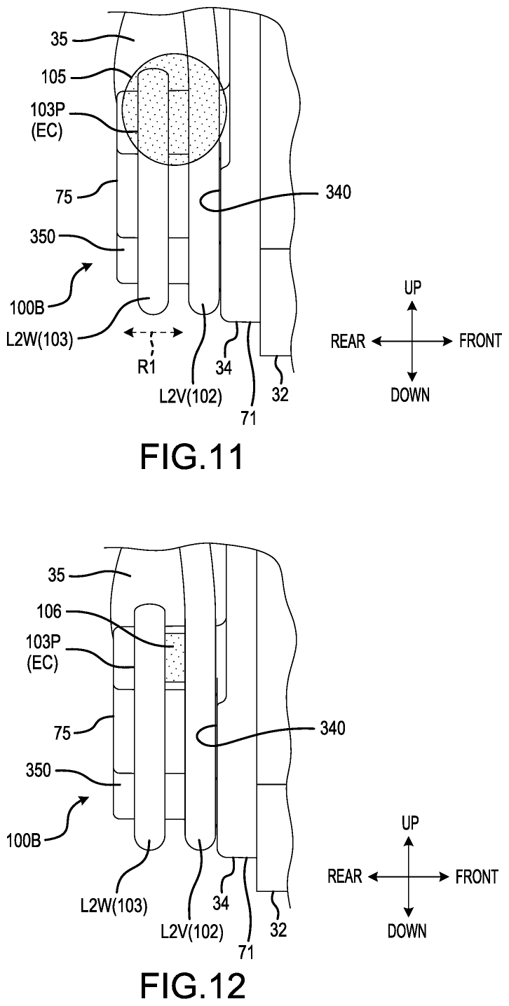

FIG. 11 is a partial, enlarged view of the stator 20 according to the present embodiment. FIG. 11 shows the second wire 102 and the third wire 103, which have been fixed by the bonding agent 105, in the range 100B. The second wire 102 is disposed such that it is in contact with the rear insulator 34. At least a portion of the second wire 102 is in contact with the support surface 340 of the ring part 71. At least a portion of the second wire 102 is in contact with the outer-circumferential surface 350 of the rear-guide rib 75. In the range 100B, the third wire 103 is disposed such that it covers the second wire 102. At least a portion of the third wire 103 is in contact with the outer-circumferential surface 350 of the rear-guide rib 75. In the present embodiment, the third wire 103 is pulled around rearward of the second wire 102. That is, the third wire 103 is pulled around to a location that is spaced farther apart from the support surface 340 than is the second wire 102.

As shown in FIG. 11, the second wire 102 is spaced apart from the specified portion 103P of the third wire 103. At least a portion of the bonding agent 105 is disposed between the second wire 102 and the specified portion 103P of the third wire 103. At least a portion of the bonding agent 105 is hardened in the state in which it has penetrated into the space between the second wire 102 and the specified portion 103P of the third wire 103. The bonding agent 105 functions as an intermediate member that separates the second wire 102 from the specified portion 103P of the third wire 103.

In addition, the bonding agent 105 fixes the second wire 102 and the specified portion 103P of the third wire 103 such that they are incapable of relative movement. The bonding agent 105 fixes the second wire 102, the third wire 103, and the rear insulator 34 such that they are incapable of relative movement.

The bonding agent 105 is an ultraviolet-light-setting type. That is, the bonding agent 105 hardens (cures) by being irradiated with ultraviolet light.

Likewise, in the range 100A, the second wire 102 is disposed such that it covers the first wire 101. The first wire 101 is spaced apart from the specified portion 102P of the second wire 102. At least a portion of the bonding agent 105 is disposed between the first wire 101 and the specified portion 102P of the second wire 102. The bonding agent 105 fixes the first wire 101, the second wire 102, and the rear insulator 34 such that they are incapable of relative movement.

In the range 100B, the bonding agent 105 is applied only to a portion of the second wire 102 and a portion of the third wire 103. That is, in the range 100B, the bonding agent 105 is applied only to the specified portion 103P, which is the winding-end portion EC of the third wire 103 disposed such that it covers the second wire 102, and the portion of the second wire 102 that is covered by the specified portion 103P. In the range 100B, the bonding agent 105 is not applied to the winding-start portion SC of the third wire 103. In addition, the bonding agent 105 is also not applied to an intermediate portion of the third wire 103 between the winding-end portion EC and the winding-start portion SC. The second wire 102 and the winding-start portion SC of the third wire 103 are disposed in a contactable manner. The second wire 102 and the winding-start portion SC of the third wire 103 are disposed such that they are capable of relative movement.

Likewise, in the range 100A, the bonding agent 105 is applied only to a portion of the first wire 101 and a portion of the second wire 102. That is, in the range 100A, the bonding agent 105 is applied only to the specified portion 102P, which is the winding-end portion EC of the second wire 102 disposed such that it covers the first wire 101, and the portion of the first wire 101 that is covered by the specified portion 102P. In the range 100A, the bonding agent 105 is not applied to the winding-start portion SC of the second wire 102. In addition, the bonding agent 105 is also not applied to an intermediate portion of the second wire 102 between the winding-end portion EC and the winding-start portion SC. The first wire 101 and the winding-start portion SC of the second wire 102 are disposed in a contactable manner. The first wire 101 and the winding-start portion SC of the second wire 102 are disposed such that they are capable of relative movement.

<Effects>

According to the present embodiment as explained above, at least a portion of the first wire 101 and at least a portion of the second wire 102 are disposed in the same range 100A in the circumferential direction. However, the first wire 101 and the second wire 102 are disposed in a non-contactable manner in at least a portion of the range 100A. Consequently, for example, even if the motor 8 vibrates, rubbing of the first wire 101 and the second wire 102 against one another is curtailed. Accordingly, deterioration of the surface of the first wire 101 and of the surface of the second wire 102 is curtailed. Because deterioration of the surface of the first wire 101 and of the surface of the second wire 102 is curtailed, the occurrence of insulation failures (layer shorts or short circuits) is curtailed. This applies likewise in the range 100B.

The present inventors discovered that, in embodiments in which the first wire 101 overlaps the second wire 102 in the range 100A, the portion that tends to deteriorate due to wear is the specified portion 102P of the second wire 102, which is the winding-end portion EC of the second wire 102 that is disposed such that it covers the first wire 101. That is, they discovered that, in the range 100A, owing to the fact that the first wire 101 is pulled around the rear insulator 34 first, the portion along which the first wire 101 and the second wire 102 rub against one another aggressively is the portion in which the second wire 102, the winding of which has ended around the coil 35, covers (contacts) the first wire 101. As the reason why the specified portion 102P of the second wire 102 tends to deteriorate due to wear, it is hypothesized that, because the winding-end portion EC of the second wire 102 is not pressed against the rear insulator 34 by a separate portion of the wire 100, the winding-end portion EC tends to move in response to vibration of the motor 8. Likewise, in the range 100B as well, as the reason why the specified portion 103P of the third wire 103 tends to deteriorate due to wear, it is hypothesized that, because the winding-end portion EC of the third wire 103 is not pressed against the rear insulator 34 by a separate portion of the wire 100, the winding-end portion EC tends to move in response to vibration of the motor 8. For example, as shown by an arrow R1 in FIG. 11, there is a possibility that the specified portion 103P of the third wire 103 will move in the front-rear direction. In the present embodiment, because the first wire 101 and the specified portion 102P of the second wire 102 are disposed in a non-contactable manner, deterioration of the surface of the first wire 101 and of the surface of the second wire 102 is effectively curtailed. Likewise, in the range 100B as well, because the second wire 102 and the specified portion 103P of the third wire 103 are disposed in a non-contactable manner, deterioration of the surface of the first wire 101 and of the surface of the second wire 102 is effectively curtailed. In addition, because the second wire 102 and the specified portion 103P of the third wire 103 are fixed by the bonding agent 105, movement (in the direction of arrow R1 in FIG. 11) of the specified portion 103P, which is the winding-end portion EC of the third wire 103 disposed such that it covers the second wire 102, in the front-rear direction is curtailed.

In addition, the present inventors discovered that deterioration due to wear does not occur much in portions outside of the specified portion 102P of the second wire 102. That is, they discovered that, in the winding-start portion SC of the second wire 102, rubbing together of the first wire 101 and the second wire 102 does not occur much. As the reason why the portions outside of the specified portion 102P of the second wire 102 tend not to deteriorate, it is hypothesized that, because the winding-start portion SC of the second wire 102 is tightly fastened to the wound coil 35, the winding-start portion SC tends not to move. Accordingly, the first wire 101 and the winding-start portion SC of the second wire 102 may be disposed in a contactable manner. The same also applies to the specified portion 103P of the third wire 103.

In addition, the present inventors discovered that even with the winding-end portion EC of the second wire 102, deterioration due to wear does not occur much in portions covered by the third wire 103. As the reason why the portions covered by the third wire 103—even the winding-end portion EC of the second wire 102—tend not to deteriorate, it is hypothesized that, because the winding-end portion EC of the second wire 102 is pressed against the rear insulator 34 by the third wire 103, the winding-end portion EC tends not to move in response to vibration of the motor 8. Accordingly, the third wire 103 and the winding-end portion EC of the second wire 102, which is covered by the third wire 103, may be disposed in a contactable manner.

In the state in which the first wire 101 and the specified portion 102P of the second wire 102 are spaced apart in the range 100A, the bonding agent 105 fixes the first wire 101 and the second wire 102 to the rear insulator 34. Thereby, the first wire 101 and the specified portion 102P of the second wire 102 can be spaced apart with a simple configuration. In addition, because at least a portion of the bonding agent 105 is disposed between the first wire 101 and the specified portion 102P of the second wire 102, contact between the first wire 101 and the specified portion 102P of the second wire 102 is sufficiently curtailed. The same also applies to the range 100B.

In the range 100A, the bonding agent 105 is applied only to the winding-end portion EC of the second wire 102 and is not applied to the winding-start portion SC of the second wire 102 and to an intermediate portion of the second wire 102. Thereby, wastage of the bonding agent 105, which is expensive, is curtailed. In addition, the manufacturing time needed to apply the bonding agent 105 is shortened. The same also applies to the range 100B.

The bonding agent 105 is an ultraviolet-light-setting type. Accordingly, after the bonding agent 105 has been applied to the wire 100, the bonding agent 105 can be hardened (cured) in a short time merely by illuminating the bonding agent 105 with ultraviolet light.

### Other Embodiments

It is noted that, in the embodiment described above, the first wire 101 and the specified portion 102P of the second wire 102 are configured such that they are spaced apart. The first wire 101 and the specified portion 102P of the second wire 102 may be in contact with one another. In the state in which the first wire 101 and the specified portion 102P of the second wire 102 have been brought into contact with one another, the first wire 101 and the specified portion 102P of the second wire 102 become incapable of relative movement owing to their being fixed by the bonding agent 105. Because the first wire 101 and the specified portion 102P of the second wire 102 are incapable of relative movement, the first wire 101 and the second wire 102 do not rub against one another, and therefore deterioration of the surface of the first wire 101 and of the surface of the second wire 102 is curtailed. In addition, if the first wire 101 and the specified portion 102P of the second wire 102 are fixed by the bonding agent 105 such that they are incapable of relative movement, the first wire 101 and the second wire 102 do not have to be fixed to the rear insulator 34. The same applies also to the fixing of the second wire 102 and the specified portion 103P of the third wire 103.

It is noted that the bonding agent 105 may be a thermosetting type.

### Second Embodiment

A second embodiment will now be explained. In the explanation below, structural elements that are the same as or equivalent to those in the embodiment described above are assigned the same symbols, and therefore explanations thereof are simplified or omitted.

FIG. 12 is a partial, enlarged view of the stator 20 according to the present embodiment. As shown in FIG. 12, the stator 20 comprises an intermediate member 106, which has insulation characteristics and is disposed between the second wire 102 and the specified portion 103P of the third wire 103. The intermediate member 106 is fixed to the rear insulator 34. Owing to interposing of the intermediate member 106, the second wire 102 and the specified portion 103P of the third wire 103 are non-contactable. In the range 100B, the intermediate member 106 is disposed only at (along) the specified portion 103P (the winding-end portion EC) of the third wire 103 and is not disposed at (along) the winding-start portion SC or an intermediate portion of the third wire 103.

The intermediate member 106 may be formed of rubber or another elastomer. In this case, deterioration of the surface of the second wire 102 and of the surface of the third wire 103, which are in contact with the intermediate member 106, is curtailed. It is noted that the intermediate member 106 may be formed of synthetic resin.

It is noted that the intermediate member 106 may be disposed (interposed, interleaved) between the first wire 101 and the specified portion 102P of the second wire 102.

It is noted that the intermediate member 106 does not have to be fixed to the rear insulator 34.

As explained above, in the present embodiment as well, the second wire 102 and the specified portion 103P of the third wire 103 are non-contactable. Consequently, for example, even if the motor 8 vibrates, rubbing together of the second wire 102 and the third wire 103 is curtailed. Accordingly, deterioration of the surface of the second wire 102 and of the surface of the third wire 103 is curtailed. Because deterioration of the surface of the second wire 102 and the surface of the third wire 103 is curtailed, the occurrence of insulation failures (layer shorts) is curtailed. The same applies also in the range 100A.

### Third Embodiment

A third embodiment will now be explained. In the explanation below, structural elements that are the same as or equivalent to those in the embodiment described above are assigned the same symbols, and therefore explanations thereof are simplified or omitted.

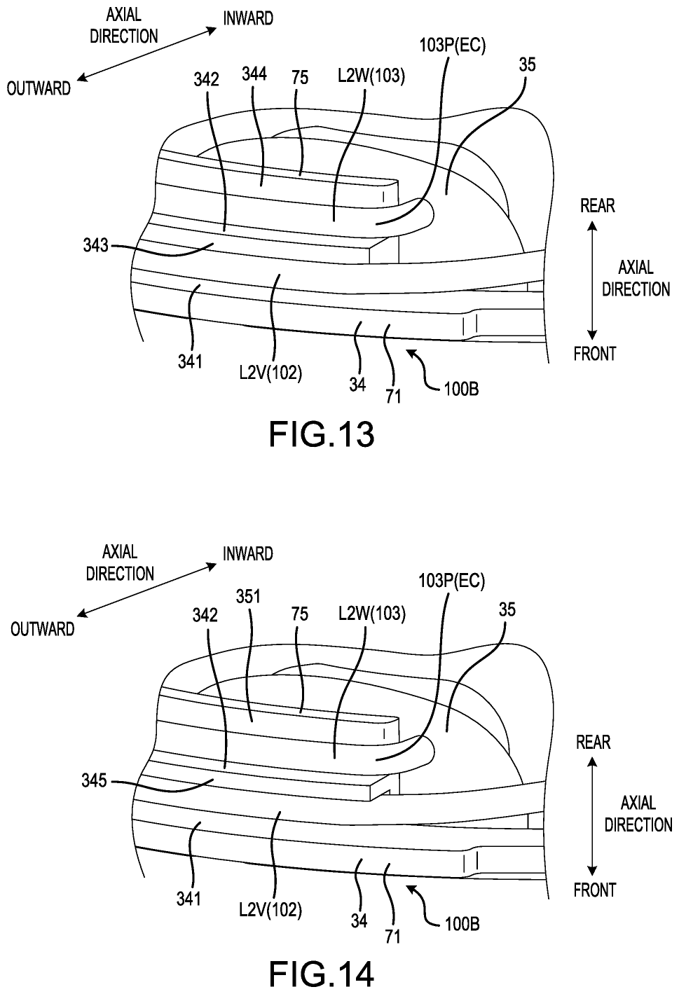

FIG. 13 is an oblique view of a portion of the stator 20 according to the present embodiment. As shown in FIG. 13, the rear insulator 34 has a first support surface 341, which supports the second wire 102, and a second support surface 342, which supports the third wire 103 in the state in which the second wire 102 and the specified portion 103P of the third wire 103 are spaced apart. The first support surface 341 and the second support surface 342 are each planar surfaces that are orthogonal to the rotational axis AX. The first support surface 341 and the second support surface 342 face rearward.

The first support surface 341 and the second support surface 342 are disposed at locations that differ in the axial direction. In addition, the first support surface 341 and the second support surface 342 are disposed at locations that differ in the radial direction. In the example shown in FIG. 13, the second support surface 342 is disposed rearward of the first support surface 341. The first support surface 341 is disposed outward of the second support surface 342 in the radial direction. That is, a difference in level is formed between the first support surface 341 and the second support surface 342.

The first support surface 341 is a portion of the rear surface of the ring part 71. Each of the rear-guide ribs 75 has a first outer-circumferential surface 343, which links the end part of the first support surface 341 that is inward in the radial direction and the end part of the second support surface 342 that is outward in the radial direction, and a second outer-circumferential surface 344, which links the end part of the second support surface 342 that is inward in the radial direction and the rear-end portion of the rear-guide rib 75. The second outer-circumferential surface 344 is disposed rearward of the first outer-circumferential surface 343. The second outer-circumferential surface 344 is disposed inward of the first outer-circumferential surface 343 in the radial direction. The first outer-circumferential surface 343 and the second outer-circumferential surface 344 are each parallel to the rotational axis AX. The first outer-circumferential surface 343 and the second outer-circumferential surface 344 each face outward in the radial direction. The second wire 102 is supported by (on) the first support surface 341 and the first outer-circumferential surface 343. The third wire 103 is supported by (on) the second support surface 342 and the second outer-circumferential surface 344.

As explained above, in the present embodiment as well, the second wire 102 and the specified portion 103P of the third wire 103 are non-contactable. Consequently, for example, even if the motor 8 vibrates, rubbing together of the second wire 102 and the third wire 103 is curtailed. Accordingly, deterioration of the surface of the second wire 102 and of the surface of the third wire 103 is curtailed. Because deterioration of the surface of the second wire 102 and of the surface of the third wire 103 is curtailed, the occurrence of insulation failures (layer shorts) is curtailed. The same applies also in the range 100A.

### Fourth Embodiment

A fourth embodiment will now be explained. In the explanation below, structural elements that are the same as or equivalent to those in the embodiment described above are assigned the same symbols, and therefore explanations thereof are simplified or omitted.

FIG. 14 is an oblique view of a portion of the stator 20 according to the present embodiment. As shown in FIG. 14, the rear insulator 34 has: a first support surface 341, which supports the second wire 102; and a second support surface 342, which supports the third wire 103 in the state in which the second wire 102 and the specified portion 103P of the third wire 103 are spaced apart.

The first support surface 341 and the second support surface 342 are disposed at locations that differ in the axial direction. In addition, the first support surface 341 and the second support surface 342 are disposed at the same locations in the radial direction. In the example shown in FIG. 14, the second support surface 342 is disposed rearward of the first support surface 341.

The first support surface 341 is a portion of the rear surface of the ring part 71. An intermediate rib 345 is provided on an outer-circumferential surface 351 of each of the rear-guide ribs 75. The intermediate rib 345 protrudes outward in the radial direction from an intermediate portion in the axial direction of the outer-circumferential surface 351 of each of the rear-guide ribs 75. The second support surface 342 is a portion of the rear surface of the intermediate rib 345.

As explained above, in the present embodiment as well, the second wire 102 and the specified portion 103P of the third wire 103 are non-contactable. Consequently, for example, even if the motor 8 vibrates, rubbing together of the second wire 102 and the third wire 103 is curtailed. Accordingly, deterioration of the surface of the second wire 102 and of the surface of the third wire 103 is curtailed. Because deterioration of the surface of the second wire 102 and the surface of the third wire 103 is curtailed, the occurrence of insulation failures (layer shorts) is curtailed. The same applies also in the range 100A.

### Fifth Embodiment

A fifth embodiment will now be explained. In the explanation below, structural elements that are the same as or equivalent to those in the embodiment described above are assigned the same symbols, and therefore explanations thereof are simplified or omitted.

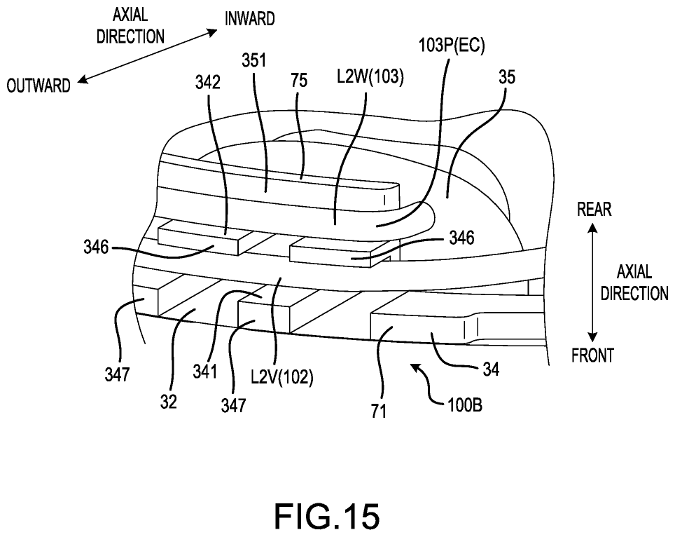

FIG. 15 is an oblique view of a portion of the stator 20 according to the present embodiment. As shown in FIG. 15, the rear insulator 34 has: the first support surface 341, which supports the second wire 102; and the second support surface 342, which supports the third wire 103 in the state in which the second wire 102 and the specified portion 103P of the third wire 103 are spaced apart.

The first support surface 341 and the second support surface 342 are disposed at locations that differ in the axial direction. In addition, the first support surface 341 and the second support surface 342 are disposed at the same locations in the radial direction. In the example shown in FIG. 15, the second support surface 342 is disposed rearward of the first support surface 341.

The first support surfaces 341 are disposed spaced apart in the circumferential direction. The second support surfaces 342 are disposed spaced apart in the circumferential direction. The first support surfaces 341 and the second support surfaces 342 are disposed such that they do not overlap within a plane that is orthogonal to the rotational axis AX.

A partitioned rib 346 is provided on the outer-circumferential surface 351 of each of the rear-guide ribs 75. The partitioned rib 346 protrudes outward in the radial direction from an intermediate portion in the axial direction of the outer-circumferential surface 351 of each of the rear-guide ribs 75. The partitioned ribs 346 are provided spaced apart in the circumferential direction. The second support surface 342 is provided on each of the partitioned ribs 346. The second support surfaces 342 are the rear surfaces of the partitioned ribs 346.

Partitioned ribs 347 are provided on a rear surface of the stator core 32. The partitioned ribs 347 protrude rearward from the rear surface of the stator core 32. The partitioned ribs 347 are provided spaced apart in the circumferential direction. The first support surface 341 is provided on each of the partitioned ribs 347. The first support surfaces 341 are the rear surfaces of the partitioned ribs 347.

As explained above, in the present embodiment as well, the second wire 102 and the specified portion 103P of the third wire 103 are non-contactable. Consequently, for example, even if the motor 8 vibrates, rubbing together of the second wire 102 and the third wire 103 is curtailed. Accordingly, deterioration of the surface of the second wire 102 and of the surface of the third wire 103 is curtailed. Because deterioration of the surface of the second wire 102 and the surface of the third wire 103 is curtailed, the occurrence of insulation failures (layer shorts) is curtailed. In addition, in the present embodiment, the rear surface of the stator core 32 is exposed between the partitioned ribs 347 that are adjacent to one another. Thereby, a heat-dissipating effect of the stator core 32 is improved. In addition, in embodiments in which the rear insulator 34 is manufactured using a mold, the rear insulator 34 can be manufactured smoothly owing to the structure of the present embodiment. The same applies also in the range 100A.

### Sixth Embodiment

A sixth embodiment will now be explained. In the explanation below, structural elements that are the same as or equivalent to those in the embodiment described above are assigned the same symbols, and therefore explanations thereof are simplified or omitted.

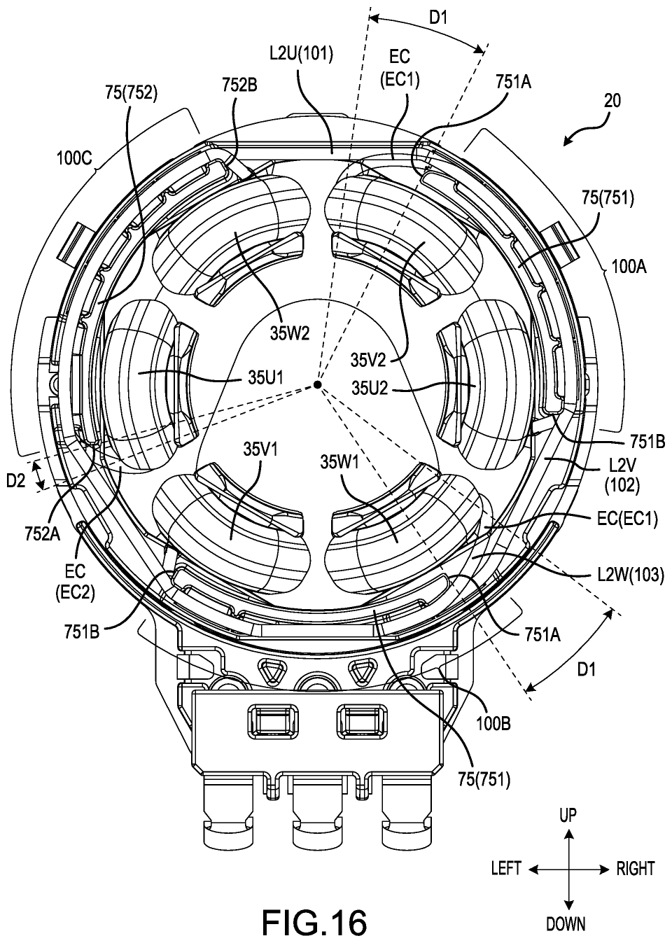

FIG. 16 is a rear view of the stator 20 according to the present embodiment. The same as in the embodiments described above, the rear insulator 34 comprises the rear-guide ribs 75 that guide the wire 100 (in particular, the first wire 101, the second wire 102, and the third wire 103).

The same as in the embodiments described above, in the rear insulator 34, the range 100A is defined by a portion in the circumferential direction, and the range 100B is defined by a portion in the circumferential direction. In addition, in the rear insulator 34, a range 100C is defined by a portion in the circumferential direction.

The same as in the embodiments described above, in the range 100A, the first wire 101 and the second wire 102 overlap, and in the range 100B, the second wire 102 and the third wire 103 overlap. In the range 100C, the third wire 103 and the first wire 101 overlap.

In the present embodiment, the winding-end portions EC of the wire 100 include: winding-end portions EC1 in a first state in which they are disposed such that they cover a separate wire 100; and a winding-end portion EC2 in a second state in which it is disposed such that it is covered by the separate wire 100.

In the range 100A, the winding-end portion EC of the second wire 102 is the winding-end portion EC1 in the first state in which it is disposed such that it covers the first wire 101.

In the range 100B, the winding-end portion EC of the third wire 103 is the winding-end portion EC1 in the first state in which it is disposed such that it covers the second wire 102.

In the range 100C, the winding-end portion EC of the first wire 101 is the winding-end portion EC2 in the second state in which it is disposed such that it is covered by the third wire 103.

The rear-guide ribs 75 include first guide ribs 751, which support the winding-end portions EC1 in the first state, and a second guide rib 752, which supports the winding-end portion EC2 in the second state. The first guide ribs 751 are disposed in the range 100A and the range 100B. The second guide rib 752 is disposed in the range 100C.

In the circumferential direction, each of the first guide ribs 751 has a pair of end parts 751A, 751B. Each of the end parts 751A is nearer to its corresponding winding-end portion EC1 than is its corresponding end part 751B. In the circumferential direction, the second guide rib 752 has a pair of end parts 752A, 752B. The end part 752A is nearer to the winding-end portion EC2 than is the end part 752B.

In the circumferential direction, a distance D1, which is the distance between the winding-end portion EC1 in the first state and the end part 751A of the first guide rib 751 that is near the winding-end portion EC1 in the first state, is longer than a distance D2, which is the distance between the winding-end portion EC2 in the second state and the end part 752A of the second guide rib 752 that is near the winding-end portion EC2 in the second state.

That is, the area of each of the first guide ribs 751 opposing the coils 35 is smaller than the area of the second guide rib 752 opposing the coils 35.

In the range 100A, the winding-end portion EC1 of the second wire 102 is not bent greatly and is supported by the corresponding first guide rib 751. Likewise, in the range 100B, the winding-end portion EC1 of the third wire 103 is not bent greatly and is supported by the corresponding first guide rib 751. On the other hand, in the range 100C, the winding-end portion EC2 of the first wire 101 is bent greatly and then supported by the second guide rib 752. That is, in the present embodiment, a bend angle of each of the winding-end portions EC1 in the first state is smaller than a bend angle of the winding-end portion EC2 in the second state.

The specified portion 102P and the specified portion 103P explained in the embodiments described above include the winding-end portions EC1 in the first state. As described above, there is a strong possibility that the winding-end portions EC1 (the specified portion 102P and the specified portion 103P) in the first state could deteriorate due to wear. However, in the present embodiment, because the bend angle of each of the winding-end portions EC1 in the first state is smaller than the bend angle of the winding-end portion EC2 in the second state, peeling of the insulating film (coating) is curtailed even in embodiments in which the winding-end portions EC in the first state rub against another portion of the wire 100.

### Seventh Embodiment

A seventh embodiment will now be explained. In the explanation below, structural elements that are the same as or equivalent to those in the embodiment described above are assigned the same symbols, and therefore explanations thereof are simplified or omitted.

<Electric Work Machine>

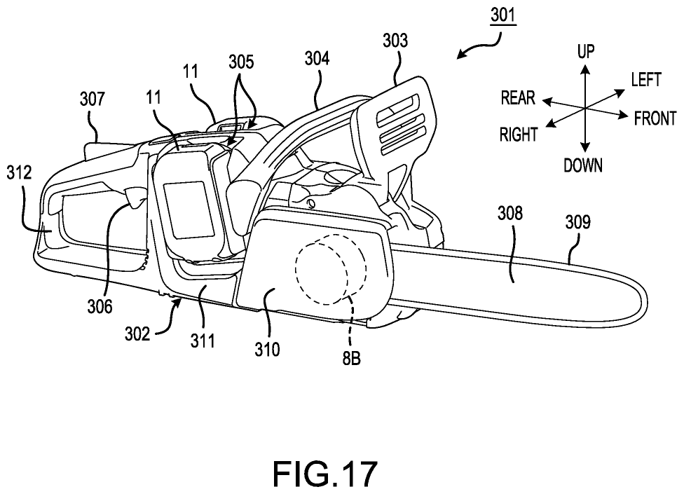

FIG. 17 is an oblique view of an electric work machine 301 according to the present embodiment. In the present embodiment, the electric work machine 301 is a chain saw, which is one type of horticulture tool (also known as “outdoor power equipment”).

The electric work machine 301 comprises a housing 302, a hand guard 303, a grip part 304, battery-mounting parts 305, a trigger switch 306, a trigger-lock lever (lock-off lever) 307, a guide bar 308, and a saw chain 309.

The housing 302 is formed of synthetic resin. The housing 302 comprises a motor-housing part 310, a battery-holding part 311, and a rear-grip part 312.

The motor-housing part 310 houses a motor 8B. The battery-holding part 311 is connected to a rear-end portion of the motor-housing part 310. The battery-holding part 311 comprises the battery-mounting parts 305, on which battery packs 11 are respectively mounted. The battery-holding part 311 houses a controller. The rear-grip part 312 is connected to a rear-end portion of the battery-holding part 311. The trigger switch 306 and the trigger-lock lever 307 are disposed on the rear-grip part 312. When the trigger-lock lever 307 is manually operated, manual operation of the trigger switch 306 is then permitted.

The guide bar 308 extends forward from the housing 302. The guide bar 308 is a plate-shaped member that is elongated in the front-rear direction. The saw chain 309 comprises a plurality of linked cutters (drive links having cutting edges). The saw chain 309 is disposed along a circumferential-edge portion of the guide bar 308. When the trigger switch 306 is manually operated, the motor 8B is driven. The motor 8B and the saw chain 309 are coupled via a power-transmission mechanism (not shown), which comprises a sprocket. In response to driving (energization) of the motor 8B, the saw chain 309 moves (travels) along the circumferential-edge portion of the guide bar 308.

The grip part 304 is formed of synthetic resin. The grip part 304 is gripped by a user. The grip part 304 is a pipe-shaped member. The grip part 304 is connected to the battery-holding part 311. A left-end portion of the grip part 304 is connected to a left-side surface of the battery-holding part 311. A right-end portion of the grip part 304 is connected to a right-side surface of the battery-holding part 311.

<Stator>

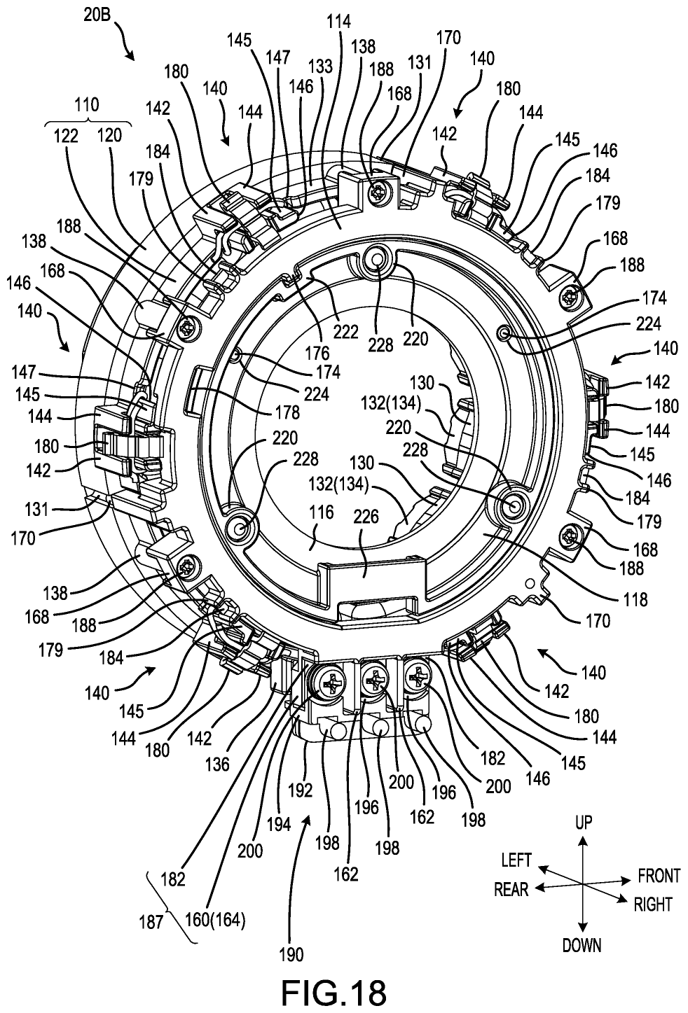

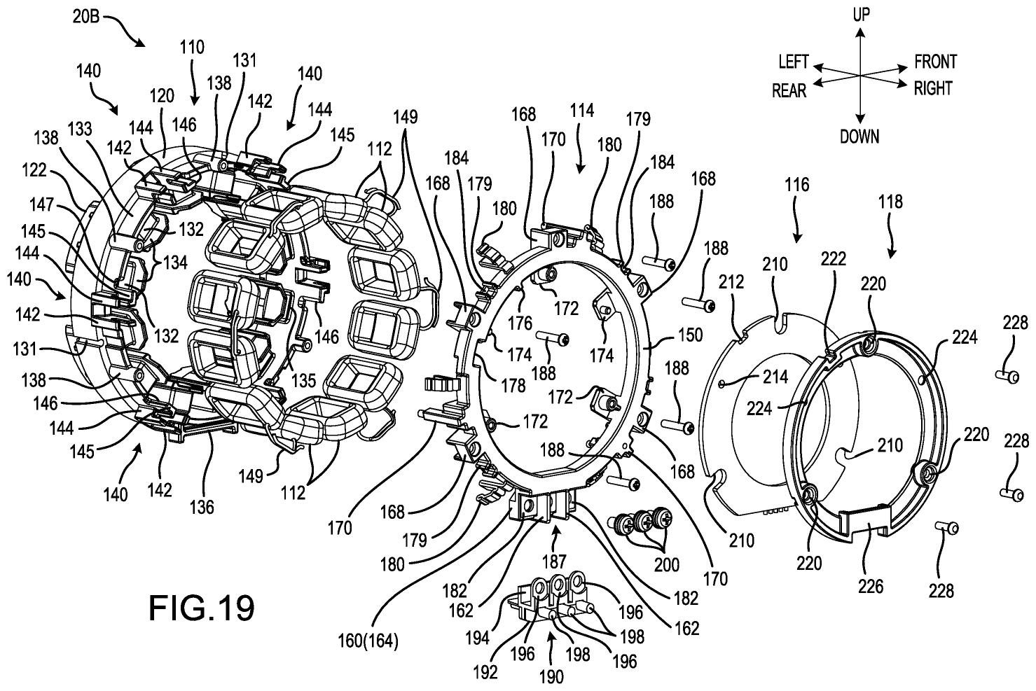

FIG. 18 is an oblique view, viewed from the right, of a stator 20B according to the present embodiment. FIG. 19 is an exploded, oblique view, viewed from the right, of the stator 20B according to the present embodiment.

The motor 8B comprises the stator 20B. The stator 20B comprises a stator-core assembly 110, coils 112, a terminal unit 114, a sensor board 116, and a board-pressing member 118.

The stator-core assembly 110 comprises a stator core 120 and an insulator 122.

The stator core 120 comprises multiple steel sheets, which are laminated. The stator core 120 has a tube shape overall. The stator core 120 comprises a plurality of teeth 130. The teeth 130 protrude inward in the radial direction from an inner surface of the stator core 120. The teeth 130 are disposed equispaced in the circumferential direction. In the present embodiment, twelve of the teeth 130 are provided. Slots are formed between adjacent teeth 130. In addition, outer grooves 131 are formed on an outer surface of the stator core 120. The outer grooves 131 extend in the axial direction (left-right direction). A plurality of the outer grooves 131 is provided. In the present embodiment, three of the outer grooves 131 are provided spaced apart in the circumferential direction.

The insulator 122 is supported by (on) the stator core 120. The insulator 122 is formed of synthetic resin. In the present embodiment, the insulator 122 comprises tooth-covering parts 132, a circular-tube part 133, wall parts 134, a connecting-part guide 136, and fusing-terminal retaining parts 140.

The tooth-covering parts 132 cover at least a portion of the surfaces of the teeth 130. At least a portion of each of the wall parts 134 protrudes in the axial direction from the corresponding tooth 130. A groove 135 is formed in a portion of each of the tooth-covering parts 132. Each of the grooves 135 extends in the circumferential direction. At least a portion of the wire that forms each of the coils 112 is disposed in the corresponding groove 135.

The circular-tube part 133 connects the plurality of tooth-covering parts 132. A portion of the circular-tube part 133 protrudes rightward of the stator core 120. The circular-tube part 133 comprises a plurality of screw-boss parts 138. The screw-boss parts 138 are disposed spaced apart in the circumferential direction. In the present embodiment, five of the screw-boss parts 138 are provided.

The connecting-part guide 136 protrudes outward in the radial direction from a lower portion of the circular-tube part 133. The connecting-part guide 136 protects a stator-side connecting part 187 and a power-supply-line-side connecting part 190, which are described below.

The fusing-terminal retaining parts 140 protect fusing terminals 180, which are described below. The fusing-terminal retaining parts 140 are provided on an outer surface of the circular-tube part 133. A plurality of the fusing-terminal retaining parts 140 is provided. In the present embodiment, six of the fusing-terminal retaining parts 140 are provided. The fusing-terminal retaining parts 140 are disposed equispaced in the circumferential direction.

Each of the fusing-terminal retaining parts 140 comprises a first projection body 142 and a second projection body 144, which are disposed in the circumferential direction. The first projection bodies 142 and the second projection bodies 144 protrude rightward of the circular-tube part 133. Each of the first projection bodies 142 comprises an inner-side protruding portion and an outer-side protruding portion. The outer-side protruding portion is disposed outward of the inner-side protruding portion in the radial direction. The inner-side protruding portion protrudes rightward of the outer-side protruding portion. Likewise, each of the second projection bodies 144 comprises an inner-side protruding portion and an outer-side protruding portion.

The inner-side protruding portion of each of the second projection bodies 144 comprises an extension part 145, which extends in the circumferential direction. Each of the extension parts 145 comprises a projecting end part 146. In the circular-tube part 133, a hollow 147 is formed at a location adjacent to each of the projecting end parts 146.

In the present embodiment, the stator-core assembly 110 is formed by integrally forming the stator core 120 and the insulator 122. For example, the stator core 120 and the insulator 122 may be integrally formed by insert-injection molding. Insert-injection molding is a forming method (molding method) in which a synthetic resin, which is to become the insulator 122, is injected into a mold while the stator core 120 is disposed within the mold.

The coils 112 are respectively wound around the tooth-covering parts 132 of the stator-core assembly 110. That is, the coils 112 are wound through (around) the insulator 122 and around the teeth 130 of the stator core 120. A plurality of the coils 112 is provided. In the present embodiment, twelve of the coils 112 are provided.

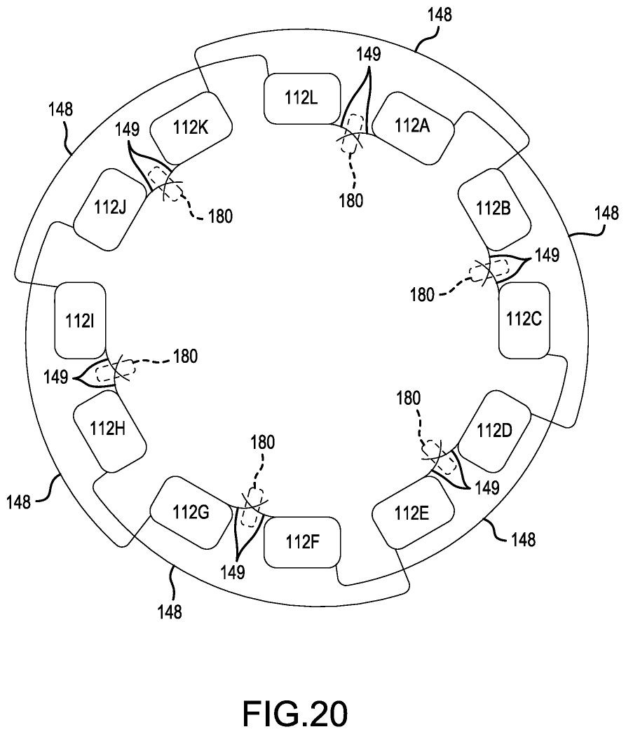

FIG. 20 schematically shows the wiring state of the coils 112 according to the present embodiment. As shown in FIG. 20, twelve of the coils 112 are provided. An extension-terminal wire 149 protrudes from each of the twelve coils 112. The fusing terminals 180 are connected to the extension-terminal wires 149. Therefore, the fusing terminals 180 are connected to the coils 112 via the extension-terminal wires 149. In the present embodiment, six of the fusing terminals 180 are provided.

The first fusing terminal 180 is connected to the extension-terminal wire 149 of a coil 112B and the extension-terminal wire 149 of a coil 112C. The coil 112B and the coil 112C are adjacent to one another.

The second fusing terminal 180 is connected to the extension-terminal wire 149 of a coil 112D and the extension-terminal wire 149 of a coil 112E. The coil 112D and the coil 112E are adjacent to one another.

The third fusing terminal 180 is connected to the extension-terminal wire 149 of a coil 112F and the extension-terminal wire 149 of a coil 112G. The coil 112F and the coil 112G are adjacent to one another.

The fourth fusing terminal 180 is connected to the extension-terminal wire 149 of a coil 112H and the extension-terminal wire 149 of a coil 112I. The coil 112H and the coil 1121 are adjacent to one another.

The fifth fusing terminal 180 is connected to the extension-terminal wire 149 of a coil 112J and the extension-terminal wire 149 of a coil 112K. The coil 112J and the coil 112K are adjacent to one another.

The sixth fusing terminal 180 is connected to the extension-terminal wire 149 of a coil 112L and the extension-terminal wire 149 of a coil 112A. The coil 112L and the coil 112A are adjacent to one another.

The coil 112A and the coil 112D are connected via a first crossover wire 148. The coil 112C and the coil 112F are connected via a second crossover wire 148. The coil 112E and the coil 112H are connected via a third crossover wire 148. The coil 112G and the coil 112J are connected via a fourth crossover wire 148. The coil 112I and the coil 112L are connected via a fifth crossover wire 148. The coil 112K and the coil 112B are connected via a sixth crossover wire 148.

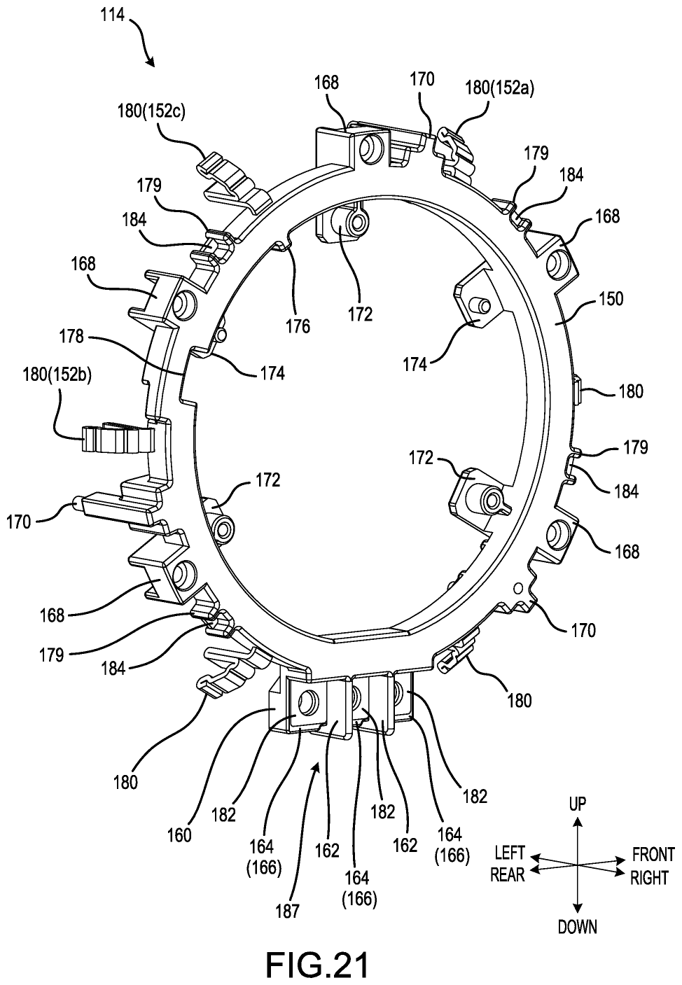

FIG. 21 is an oblique view of the terminal unit 114 according to the present embodiment. The terminal unit 114 comprises a terminal-unit main body 150, a first sheet-metal member 152a, a second sheet-metal member 152b, and a third sheet-metal member 152c.

The terminal-unit main body 150 is formed of synthetic resin. The terminal-unit main body 150 has a circular-ring shape. The terminal-unit main body 150 comprises a connecting-part base 160, which protrudes outward in the radial direction. The connecting-part base 160 comprises three cup parts 164, which are disposed along the front-rear direction. The three cup parts 164 are partitioned by partitions 162. Each of the cup parts 164 comprises a screw boss 166.

In addition, the terminal-unit main body 150 comprises a plurality of screw-hole parts 168, a plurality of pin parts 170, screw-boss parts 172, projecting parts 174, a rib 176, a circumvent part 178, and protruding parts 179.

The screw-hole parts 168 are provided on circumferential-edge portions of the terminal-unit main body 150. The screw-hole parts 168 are provided spaced apart in the circumferential direction. In the present embodiment, five of the screw-hole parts 168 are provided.

The pin parts 170 protrude leftward from an outer surface of the terminal-unit main body 150. The pin parts 170 are provided equispaced in the circumferential direction. In the present embodiment, three of the pin parts 170 are provided. The pin parts 170 are disposed in the outer grooves 131 of the stator core 120.

The first sheet-metal member 152a, the second sheet-metal member 152b, and the third sheet-metal member 152c are each formed of metal.

The first sheet-metal member 152a has an arcuate shape. The first sheet-metal member 152a comprises a fusing terminal 180, a connecting piece 182, and a projecting piece 184. The fusing terminal 180 is provided on (at) a tip portion of the first sheet-metal member 152a. The fusing terminal 180 comprises a folded portion. The connecting piece 182 is provided on a base-end portion of the first sheet-metal member 152a. The projecting piece 184 protrudes outward in the radial direction.

The second sheet-metal member 152b has an arcuate shape. Like the first sheet-metal member 152a, the second sheet-metal member 152b comprises a fusing terminal 180, a connecting piece 182, and a projecting piece 184.

The third sheet-metal member 152c has an arcuate shape. Like the first sheet-metal member 152a and the second sheet-metal member 152b, the third sheet-metal member 152c comprises a fusing terminal 180, a connecting piece 182, and a projecting piece 184.

In the present embodiment, the terminal unit 114 is formed by integrally forming (molding) the terminal-unit main body 150, the first sheet-metal member 152a, the second sheet-metal member 152b, and the third sheet-metal member 152c. For example, the first sheet-metal member 152a, the second sheet-metal member 152b, and the third sheet-metal member 152c may be disposed in a mold and then a synthetic resin may be injected to form the polymer portion of the terminal-unit main body 150, which integrally holds the members 152a-152c. Owing to being formed integrally, the protruding parts 179 and the projecting pieces 184 are aligned with one another.

The fusing terminals 180 and the connecting pieces 182 of the first sheet-metal member 152a, of the second sheet-metal member 152b, and of the third sheet-metal member 152c protrude from the terminal-unit main body 150. The connecting pieces 182 are disposed such that they cover the screw bosses 166. The connecting-part base 160, the screw bosses 166, and the connecting pieces 182 form the stator-side connecting part 187.

The terminal unit 114 is connected to the insulator 122. To connect the terminal unit 114 with the insulator 122, the screw-hole parts 168 and the screw-boss parts 138 are first aligned with one another, and then screws 188 are screwed into the screw holes of the screw-boss parts 138. Thereby, the terminal unit 114 is connected to the insulator 122. Because the tip portions of the pin parts 170 of the terminal unit 114 are inserted into the outer grooves 131 of the stator core 120, the terminal unit 114 is positioned on (relative to) the stator-core assembly 110.

The fusing terminals 180 are then respectively connected to the extension-terminal wires 149. In other words, the fusing terminals 180 are connected to the coils 112 via the extension-terminal wires 149. The fusing terminals 180 are held by the fusing-terminal retaining parts 140. The extension-terminal wires 149 are fused in the state in which they are sandwiched (clamped) by the fusing terminals 180.

The stator-side connecting part 187 of the terminal unit 114 is connected to the power-supply-line-side connecting part 190. The power-supply-line-side connecting part 190 comprises a connecting-part base 192, a jaw part 194, terminal plates 196, and power-supply lines 198. The jaw part 194 protrudes from the connecting-part base 192. Three of the terminal plates 196 are provided in the front-rear direction. Each of the terminal plates 196 has a through hole. The power-supply lines 198 are connected to the terminal plates 196.

The power-supply-line-side connecting part 190 is connected to the stator-side connecting part 187 by inserting screws 200 into the through holes of the terminal plates 196 and into connecting holes of the connecting pieces 182 in the state in which the terminal plates 196 and the connecting pieces 182 of the stator-side connecting part 187 have been brought into contact. The screws 200 are screwed into the screw holes of the screw bosses 166. The jaw part 194 and the terminal plates 196 are disposed such that they sandwich the cup parts 164 and the connecting pieces 182 of the terminal unit 114.

The sensor board 116 has a plurality of rotation-detection devices (not shown) that detect the rotation of the rotor and output detection signals. Three notches 210 and one rib receiver 212 are provided on circumferential-edge portions of the sensor board 116. The notches 210 correspond to the screw-boss parts 172 of the terminal-unit main body 150. The rib receiver 212 corresponds to the rib 176 of the terminal-unit main body 150. Detection signals of the rotation-detection devices are output to the controller via signal lines (not shown).

The sensor board 116 has pin holes 214. The pin holes 214 correspond to the projecting parts 174 of the terminal-unit main body 150.

The sensor board 116 is connected to the terminal unit 114. To connect the sensor board 116 with the terminal unit 114, the screw-boss parts 172 of the terminal unit 114 are first inserted into the notches 210, and then the rib 176 of the terminal unit 114 is inserted into the rib receiver 212. In addition, the projecting parts 174 are inserted into the pin holes 214 of the sensor board 116. Thereby, the sensor board 116 and the terminal unit 114 are positioned relative to each other.

The board-pressing member 118 presses the sensor board 116 against the terminal unit 114. The board-pressing member 118 is formed of synthetic resin. The board-pressing member 118 has a circular-ring shape. The board-pressing member 118 has screw-hole parts 220, a rib receiver 222, pin holes 224, and a bridge part 226. The signal lines that are connected to the sensor board 116 pass through the bridge part 226.

The board-pressing member 118 is connected to the terminal unit 114. To connect the board-pressing member 118 with the terminal unit 114, the rib 176 of the terminal unit 114 is first inserted into the rib receiver 222 in the state in which the sensor board 116 is disposed between the board-pressing member 118 and the terminal unit 114, and then the projecting parts 174 are inserted into the pin holes 224. Thereby, the board-pressing member 118 and the terminal unit 114 are positioned.

The board-pressing member 118 is connected to the terminal unit 114 by inserting screws 228 into the screw holes of the screw-hole parts 220 and the screw holes of the screw-boss parts 172 of the terminal unit 114 in the state in which the board-pressing member 118 and the terminal unit 114 have been positioned relative to each other. The sensor board 116 is sandwiched between the board-pressing member 118 and the terminal unit 114. The sensor board 116 is fixed to the terminal unit 114.

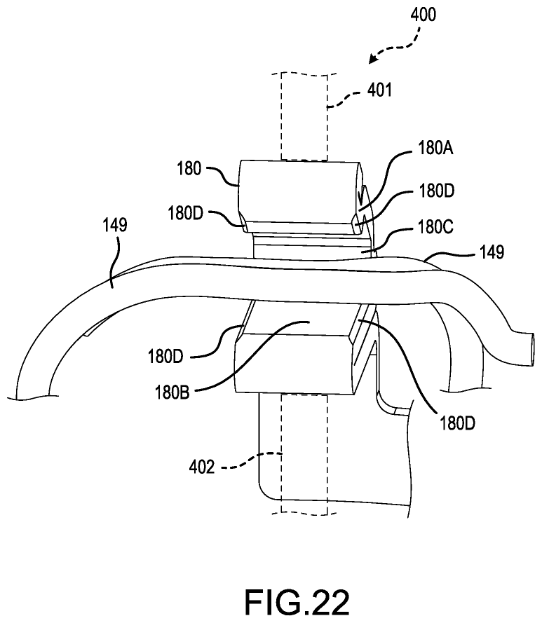

FIG. 22 is an enlarged view of one of the fusing terminals 180 according to the present embodiment. As shown in FIG. 22, the two extension-terminal wires 149 and the fusing terminal 180 are connected by using a fusing apparatus 400 to press and heat the fusing terminal 180, as will be described below. The two extension-terminal wires 149 together correspond to one of the first wire 101 or the second wire 102, as was explained in the embodiments described above.

The fusing terminal 180 comprises a first plate part 180A and a second plate part 180B, which is connected to the first plate part 180A via a folded part 180C. The extension-terminal wires 149 are disposed between the first plate part 180A and the second plate part 180B. In the present embodiment, chamfer parts 180D are formed at boundaries between an inner surface and side surfaces of the first plate part 180A. The chamfer parts 180D are also formed at boundaries between an inner surface and side surfaces of the second plate part 180B. If the boundaries between the inner surface and the side surfaces of the first plate part 180A were instead to be made sharp or the boundaries between the inner surface and the side surfaces of the second plate part 180B were instead to be made sharp, then there is a possibility that excessive stress will act on the extension-terminal wires 149 when the extension-terminal wires 149 are sandwiched by the first plate part 180A and the second plate part 180B. On the other hand, according to the present embodiment, because the first plate part 180A and the second plate part 180B each have the chamfer parts 180D, excessive stress does not act on the extension-terminal wires 149 when the extension-terminal wires 149 are sandwiched by the first plate part 180A and the second plate part 180B.

The fusing apparatus 400 comprises a first electrode 401 and a second electrode 402. In the state in which the extension-terminal wires 149 are disposed between the first plate part 180A and the second plate part 180B, the first electrode 401 and the second electrode 402 of the fusing apparatus 400 press the fusing terminal 180 such that the first plate part 180A and the second plate part 180B approach one another. In addition, while the first electrode 401 and the second electrode 402 are pressing the fusing terminal 180, the fusing apparatus 400 also heats the fusing terminal 180. Thereby, the extension-terminal wires 149 and the fusing terminal 180 are connected by fusing (melting).

The width of the first electrode 401 and the width of the second electrode 402 are each smaller (less) than the width of the fusing terminal 180. When end parts of the fusing terminal 180 in the width direction are pressed by the first electrode 401 and the second electrode 402, excessive stress could possibly act on the extension-terminal wires 149 when the extension-terminal wires 149 are sandwiched by the first plate part 180A and the second plate part 180B. On the other hand, according to the present embodiment, because the width of the first electrode 401 and the width of the second electrode 402 are each smaller (less) than the width of the fusing terminal 180, the first electrode 401 and the second electrode 402 do not press the end parts of the fusing terminal 180 in the width direction. As a result, when the extension-terminal wires 149 are sandwiched by the first plate part 180A and the second plate part 180B, excessive stress does not act on the extension-terminal wires 149.

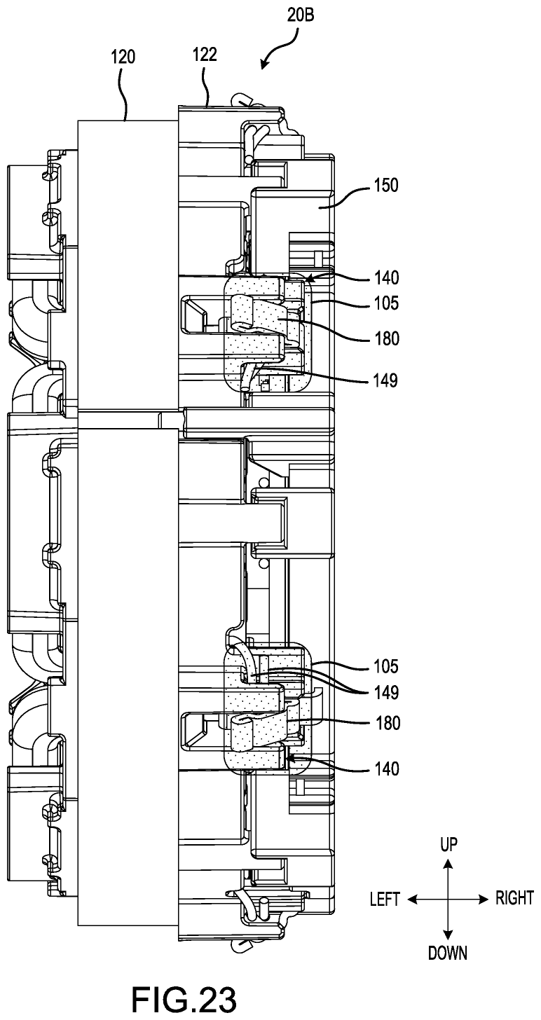

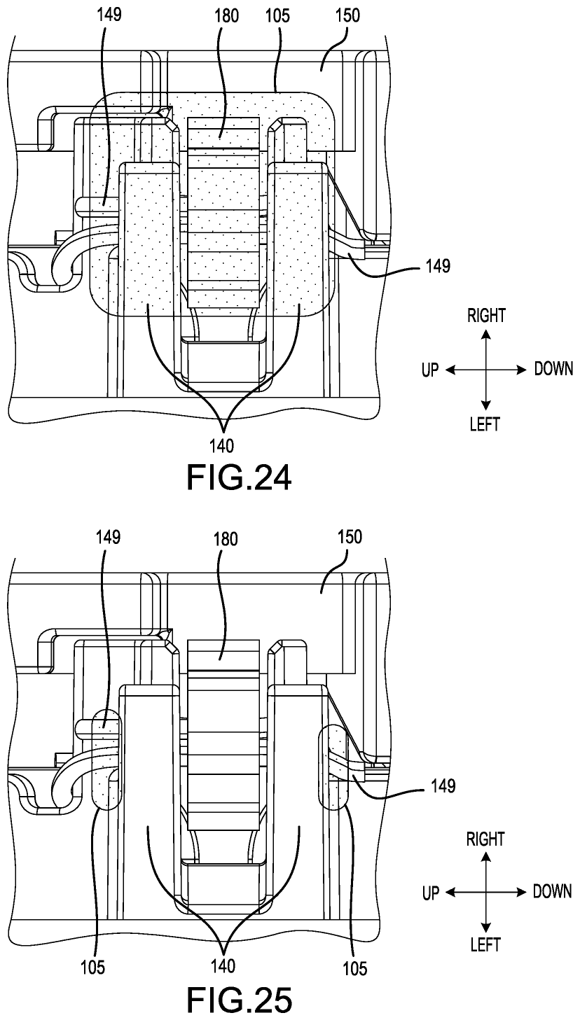

FIG. 23 is a side view of the stator 20B according to the present embodiment. FIG. 24 is an enlarged view of a portion of the stator 20B according to the present embodiment. The two extension-terminal wires 149 together correspond to one of the first wire 101 or the second wire 102, as was explained in the embodiments described above. As shown in FIG. 23, the fusing terminals 180, the two extension-terminal wires 149 (a first wire and a second wire), the fusing-terminal retaining parts 140 of the insulator 122, and the terminal-unit main body 150 are fixed by a bonding agent 105.

In the present embodiment, the motor 8B comprises: the stator core 120, which comprises the plurality of teeth 130; the insulator 122, which is supported by (on) the stator core 120; the coils 112, which are wound through (around) the insulator 122 and around the plurality of teeth 130; the terminal-unit main body 150, which is connected to the insulator 122 by the screws 188; and the fusing terminals 180, each of which is connected to its corresponding coil 112 via the two extension-terminal wires 149. The terminal unit 114 comprises the terminal-unit main body 150 and the sheet-metal members (the first sheet-metal member 152a, the second sheet-metal member 152b, and the third sheet-metal member 152c), which are integrally formed with the terminal-unit main body 150. The fusing terminals 180 are provided at tip portions of the sheet-metal members. That is, the fusing terminals 180 are supported by (on) the terminal-unit main body 150. The fusing terminals 180 are disposed on the fusing-terminal retaining parts 140 of the insulator 122 in the state in which the fusing terminals 180 are supported by the terminal-unit main body 150. The fusing terminals 180 and the extension-terminal wires 149, which have been disposed on the fusing-terminal retaining parts 140, are connected by using the fusing apparatuses 400, as was described above. After each unit of one of the fusing terminals 180 and two the extension-terminal wires 149 have been respectively fused, in each such unit, the fusing terminal 180, the two extension-terminal wires 149, the insulator 122, the fusing-terminal retaining part 140, and the terminal-unit main body 150 are then fixed by the bonding agent 105.

As described above, the fusing terminals 180 are supported by the insulator 122 and the terminal-unit main body 150, which is a separate member. When the motor 8B is driven (energized), there is a possibility that the insulator 122 and the terminal-unit main body 150 will move relative to one another. If there were to be relative movement of the insulator 122 and the terminal-unit main body 150, there is a possibility that excessive stress will concentrate on the extension-terminal wires 149, which could cause the extension-terminal wires 149 to be severed. However, according to the present embodiment, the fusing terminals 180, the extension-terminal wires 149, the insulator 122, and the terminal-unit main body 150 are fixed by the bonding agent 105. Thereby, the likelihood of severing of the extension-terminal wires 149 during operation of the motor 8 is reduced.

### Eighth Embodiment

An eighth embodiment will now be explained. In the explanation below, structural elements that are the same as or equivalent to those in the embodiments described above are assigned the same symbols, and therefore explanations thereof are simplified or omitted.

FIG. 25 is an enlarged view of a portion of the stator 20B according to the present embodiment. The present embodiment is a modified example of the embodiment that was explained with reference to FIG. 24. As shown in FIG. 25, the two extension-terminal wires 149 (a first wire and a second wire), and the fusing-terminal retaining parts 140 of the insulator 122 are fixed by the bonding agent 105. In the present embodiment, the bonding agent 105 is applied to the extension-terminal wires 149 and the fusing-terminal retaining parts 140. The bonding agent 105 is not applied to the fusing terminals 180. In addition, the bonding agent 105 is not applied to the terminal-unit main body 150. In the present embodiment as well, the likelihood of severing of the extension-terminal wires 149 during operation of the motor 8 is reduced.

### Ninth Embodiment

A ninth embodiment will now be explained. In the explanation below, structural elements that are the same as or equivalent to those in the embodiments described above are assigned the same symbols, and therefore explanations thereof are simplified or omitted.

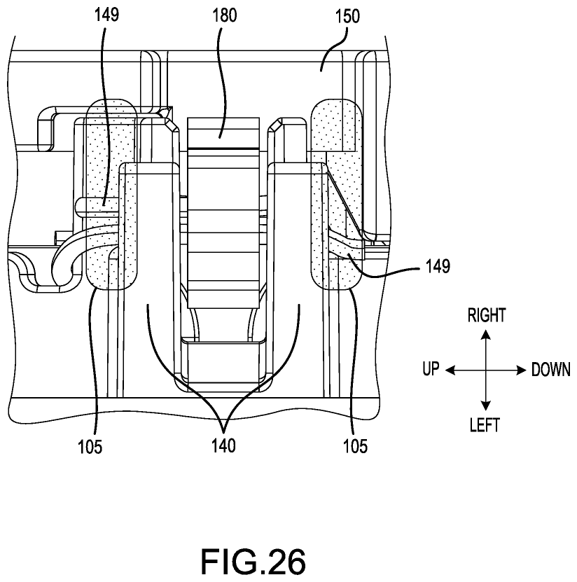

FIG. 26 is an enlarged view of a portion of the stator 20B according to the present embodiment. The present embodiment is a modified example of the embodiments that were explained with reference to FIG. 24 and FIG. 25. As shown in FIG. 26, the two extension-terminal wires 149 (a first wire and a second wire), the fusing-terminal retaining parts 140 of the insulator 122, and the terminal-unit main body 150 are fixed by the bonding agent 105. In the present embodiment, the bonding agent 105 is applied to the extension-terminal wires 149, the fusing-terminal retaining parts 140, and the terminal-unit main body 150. The bonding agent 105 is not applied to the fusing terminals 180. In the present embodiment as well, the likelihood of severing of the extension-terminal wires 149 during operation of the motor 8 is reduced.

### Other Embodiments

It is noted that, in the embodiments described above, the electric work machine 1 is a hammer driver-drill, which is one type of power tool. The power tool is not limited to a hammer driver-drill. Driver-drills, angle drills, impact drivers, grinders, rotary hammers, hammer drills, circular saws, and reciprocating saws are other illustrative examples of power tools according to the present teachings.

In the embodiments described above, the electric work machine 301 is a chain saw, which is one type of horticulture tool (outdoor power equipment). The horticulture tool is not limited to a chain saw. Hedge trimmers, lawn mowers, mowing machines, and blowers are other illustrative examples of horticulture tools according to the present teachings.

In the embodiments described above, the battery pack(s) 11, which is (are) mounted on the battery-mounting part, is (are) used as the power supply of the electric work machine. However, a commercial power supply (AC power supply) may instead be used as the power supply of the electric work machine.

Representative, non-limiting examples of the present invention were described above in detail with reference to the attached drawings. This detailed description is merely intended to teach a person of skill in the art further details for practicing preferred aspects of the present teachings and is not intended to limit the scope of the invention. Furthermore, each of the additional features and teachings disclosed above may be utilized separately or in conjunction with other features and teachings to provide improved electric work machines, such as power tools and outdoor power equipment.

Moreover, combinations of features and steps disclosed in the above detailed description may not be necessary to practice the invention in the broadest sense, and are instead taught merely to particularly describe representative examples of the invention. Furthermore, various features of the above-described representative examples, as well as the various independent and dependent claims below, may be combined in ways that are not specifically and explicitly enumerated in order to provide additional useful embodiments of the present teachings.

All features disclosed in the description and/or the claims are intended to be disclosed separately and independently from each other for the purpose of original written disclosure, as well as for the purpose of restricting the claimed subject matter, independent of the compositions of the features in the embodiments and/or the claims. In addition, all value ranges or indications of groups of entities are intended to disclose every possible intermediate value or intermediate entity for the purpose of original written disclosure, as well as for the purpose of restricting the claimed subject matter.

Additional embodiments of the present teachings include, but are not limited to:

1. An electric work machine comprising:

a motor comprising a stator and a rotor, which is rotatable relative to the stator;

wherein:

the stator comprises:
a stator core having a plurality of teeth;
an insulator supported by the stator core;
coils wound through the insulator and around the plurality of teeth;
a first wire that connects the coils of a first set; and
a second wire that connects the coils of a second set;

at least a portion of the first wire and at least a portion of the second wire are disposed in a same range in a circumferential direction; and

in at least a portion of said range, the first wire and the second wire are disposed in a non-contactable manner.

2. The electric work machine according to the above embodiment 1, wherein:

in said range, the first wire and a specified portion of the second wire are disposed in a non-contactable manner; and

the specified portion of the second wire includes a winding-end portion of the second wire, which is disposed such that it covers the first wire.

3. The electric work machine according to the above embodiment 2, wherein the first wire and a winding-start portion of the second wire are disposed in a contactable manner.

4. The electric work machine according to any one of the above embodiments 1-3, comprising a bonding agent, which fixes the first wire and the specified portion of the second wire to the insulator in the state in which the first wire and the specified portion of the second wire are spaced apart.

5. The electric work machine according to the above embodiment 4, wherein at least a portion of the bonding agent is disposed between the first wire and the specified portion of the second wire.

6. The electric work machine according to the above embodiment 4 or 5, wherein the bonding agent is an ultraviolet-light-setting type.

7. The electric work machine according to the above embodiment 1, comprising an intermediate member, which has insulation characteristics and is disposed between the first wire and a specified portion of the second wire.

8. The electric work machine according to the above embodiment 7, wherein the intermediate member is fixed to the insulator.

9. The electric work machine according to the above embodiment 7 or 8, wherein the intermediate member is formed of rubber or synthetic resin.

10. The electric work machine according to any one of the above embodiments 1-9, wherein the insulator has first support surface(s), which support(s) the first wire, and second support surface(s), which support(s) the second wire in the state in which the first wire and the specified portion of the second wire are spaced apart.

11. The electric work machine according to the above embodiment 10, wherein the first support surface(s) and the second support surface(s) are disposed at different locations in an axial direction.

12. The electric work machine according to the above embodiment 11, wherein the first support surface(s) and the second support surface(s) are disposed at different locations in a radial direction.

13. The electric work machine according to the above embodiment 10, wherein:

the first support surfaces and the second support surfaces are disposed at different locations in an axial direction and are disposed at different locations in a radial direction;

the first support surfaces are disposed spaced apart in the circumferential direction;

the second support surfaces are disposed spaced apart in the circumferential direction;

the first support surfaces and the second support surfaces are disposed such that they do not overlap within a plane that is orthogonal to a rotational axis of the motor.

14. An electric work machine comprising:

a motor comprising a stator and a rotor, which is rotatable relative to the stator;

wherein:

the stator comprises:
a stator core having a plurality of teeth;
an insulator supported by the stator core;
coils wound through the insulator and around the plurality of teeth;
a first wire that connects the coils of a first set; and
a second wire that connects the coils of a second set;

at least a portion of the first wire and at least a portion of the second wire are disposed in a same range in a circumferential direction; and

in at least a portion of said range, the first wire and the second wire are disposed in a manner incapable of relative movement.

15. The electric work machine according to the above embodiment 14, wherein:

in said range, the first wire and a specified portion of the second wire are disposed in a manner incapable of relative movement; and

the specified portion of the second wire is a winding-end portion of the second wire, which is disposed such that it covers the first wire.

16. The electric work machine according to the above embodiment 15, wherein the first wire and a winding-start portion of the second wire are disposed in a manner capable of relative movement.

17. The electric work machine according to any one of the above embodiments 14-16, comprising a bonding agent, which fixes the first wire and the specified portion of the second wire.

18. The electric work machine according to the above embodiment 17, wherein the bonding agent is an ultraviolet-light-setting type.

19. The electric work machine according to the above embodiment 17 or 18, wherein at least a portion of the bonding agent is disposed between the first wire and the specified portion of the second wire.

20. The electric work machine according to any one of the above embodiments 17-19, wherein the bonding agent fixes the first wire, the second wire, and the insulator.

21. The electric work machine according to the above embodiment 1, wherein:

the insulator comprises a guide rib that guides the first wire and the second wire;

a winding-end portion of the second wire includes a winding-end portion in a first state in which it is disposed such that it covers the first wire, and a winding-end portion in a second state in which it is disposed such that it is covered by the first wire;

the guide rib includes a first guide rib, which supports the winding-end portion in the first state, and a second guide rib, which supports the winding-end portion in the second state;

in the circumferential direction, the first guide rib has a pair of end parts, and the second guide rib has a pair of end parts; and

in the circumferential direction, a distance between the winding-end portion in the first state and one end part of the first guide rib that is near the winding-end portion in the first state is longer than a distance between the winding-end portion in the second state and one end part of the second guide rib that is near the winding-end portion in the second state.

22. The electric work machine according to any one of the above embodiments 1-21, comprising:

a fusing terminal connected to a coil via the first wire and the second wire;

wherein:

the motor comprises a terminal-unit main body, which is connected to the insulator;

the fusing terminal is disposed on a fusing-terminal retaining part of the insulator in the state in which the fusing terminal is supported by the terminal-unit main body; and

the fusing terminal, the first wire, the second wire, the fusing-terminal retaining part, and the terminal-unit main body are fixed by the bonding agent.

23. The electric work machine according to any one of the above embodiments 1-21, comprising:

a fusing terminal connected to a coil via the first wire and the second wire;

wherein:

the motor comprises a terminal-unit main body, which is connected to the insulator;

the fusing terminal is disposed on a fusing-terminal retaining part of the insulator in the state in which the fusing terminal is supported by the terminal-unit main body; and

the first wire, the second wire, and the fusing-terminal retaining part are fixed by the bonding agent.

24. The electric work machine according to any one of the above embodiments 1-21, comprising:

a fusing terminal connected to a coil via the first wire and the second wire;

wherein:

the motor comprises a terminal-unit main body, which is connected to the insulator;

the fusing terminal is disposed on a fusing-terminal retaining part of the insulator in the state in which the fusing terminal is supported by the terminal-unit main body; and

the first wire, the second wire, the fusing-terminal retaining part, and the terminal-unit main body are fixed by the bonding agent.

### EXPLANATION OF THE REFERENCE NUMBERS

1 Electric work machine
2 Grip housing
3 Main-body housing
3A Air-suction port
3B Air-exhaust port
4 Motor housing
5 Gear housing
6 Output shaft
7 Battery-mounting part
8 Motor
8B Motor
9 Rear cover
10 Power-transmission mechanism
11 Battery pack
12 Trigger switch
13 Forward/reverse-switch lever
14 Speed-change lever
15 Mode-change ring
16 Change ring
17 Light
18 Controller
19 Rotor
19S Rotor shaft
20 Stator
20B Stator
21 Fan
32 Stator core
33 Front insulator
34 Rear insulator
35 Coil
35U U-phase coil
35U1 U-phase coil
35U2 U-phase coil
35V V-phase coil
35V1 V-phase coil
35V2 V-phase coil
35W W-phase coil
35W1 W-phase coil
35W2 W-phase coil
36 Sensor circuit board
37 Tooth
37A First tooth
37B Second tooth
37C Third tooth
37D Fourth tooth
37E Fifth tooth
37F Sixth tooth
38 Slot
39 Ring part
40 Insulating rib
41 Mating rib
42 Screw boss
43 Positioning pin
44 Coupling plate
45 Partitioning rib
46A Coupling piece
46B Coupling piece
46C Coupling piece
47 Nut
48 Positioning projection
49 Groove
50 Recessed part
51A Fusing terminal
51B Fusing terminal
51C Fusing terminal
52 Fusing part
53 Extension part
54 Sandwiching piece
55 Support piece
56 Support piece
57 Retaining projection
58 Sandwiching projection
59 Bent part
60 Through hole
61 Through hole
62 Square hole
63 Lower tab
64 Transverse tab
65 Fusing part
66 Extension part
67 Sandwiching piece
68 Retaining part
69 Through hole
70 Lower tab
71 Ring part
72 Insulating rib
73 Mating rib
74 Front-guide rib
75 Rear-guide rib
76 Terminal unit
77A Lead-wire-side terminal
77B Lead-wire-side terminal
77C Lead-wire-side terminal
78 Tip portion
79 Through hole
80 Intermediate part
81 Base-end portion
82 Resin part
83 Receiving piece
85 Disk part
86 Through hole
87 Screw-stop piece
88 Through hole
89 Positioning piece
90 Through hole
91 Connecting piece
92 Rotation-detection device
93 Connecting part
94 Signal line
96 Screw
97 Screw
100 Wire
100A Range
100B Range
100C Range
101 First wire
102 Second wire
102P Specified portion
103 Third wire
103P Specified portion
105 Bonding agent
106 Intermediate member
110 Stator-core assembly
112 Coil
114 Terminal unit
116 Sensor board
118 Board-pressing member
120 Stator core
122 Insulator
130 Tooth
131 Outer groove
132 Tooth-covering part
133 Circular-tube part
134 Wall part
135 Groove
136 Connecting-part guide
138 Screw-boss part
140 Fusing-terminal retaining part
142 First projection body
144 Second projection body
145 Extension part
146 Projecting end part
147 Hollow
148 Crossover wire
149 Extension-terminal wire
150 Terminal-unit main body
152a First sheet-metal member
152b Second sheet-metal member
152c Third sheet-metal member
160 Connecting-part base
162 Partition
164 Cup part
166 Screw boss
168 Screw-hole part
170 Pin part
172 Screw-boss part
174 Projecting part
176 Rib
178 Circumvent part
179 Protruding part
180 Fusing terminal
180A First plate part
180B Second plate part
180C Folded part
180D Chamfer part
182 Connecting piece
184 Projecting piece
187 Stator-side connecting part
188 Screw
190 Power-supply-line-side connecting part
192 Connecting-part base
194 Jaw part
196 Terminal plate
198 Power-supply line
200 Screw
210 Notch
212 Rib receiver
214 Pin hole
220 Screw-hole part
222 Rib receiver
224 Pin hole
226 Bridge part
228 Screw
301 Electric work machine
302 Housing
303 Hand guard
304 Grip part
305 Battery-mounting part
306 Trigger switch
307 Trigger-lock lever
308 Guide bar
309 Saw chain
310 Motor-housing part
311 Battery-holding part
312 Rear-grip part
340 Support surface
341 First support surface
342 Second support surface
343 First outer-circumferential surface
344 Second outer-circumferential surface
345 Intermediate rib
346 Partitioned rib
347 Partitioned rib
350 Outer-circumferential surface
351 Outer-circumferential surface
400 Fusing apparatus
401 First electrode
402 Second electrode
751 First guide rib
751A End part
751B End part
752 Second guide rib
752A End part
752B End part
L1 Crossover wire
L1A Crossover wire
L1B Crossover wire
L1C Crossover wire
L2 Crossover wire
L2U Crossover wire
L2V Crossover wire
L2W Crossover wire
SC Winding-start portion
EC Winding-end portion
EW Winding-end portion
SW Winding-start portion

1. An electric work machine comprising:
a motor comprising a stator and a rotor, which is rotatable relative to the stator;
wherein:
the stator comprises:
a stator core having a plurality of teeth;
an insulator supported by the stator core;
coils wound through the insulator and around the plurality of teeth;
a first wire that electrically connects a first set of the coils; and
a second wire that electrically connects a second set of the coils;
at least a portion of the first wire and at least a portion of the second wire are disposed in a same range in a circumferential direction of the stator; and
in at least a portion of said range, the first wire and the second wire are disposed in a non-contactable manner and/or in a manner such that relative movement is not possible.

2. The electric work machine according to claim 1, wherein:
in said range, the first wire and a specified portion of the second wire are disposed in a non-contactable manner and/or in a manner such that relative movement is not possible; and
the specified portion of the second wire is or includes a winding-end portion of the second wire, which is disposed such that it covers the first wire.

3. The electric work machine according to claim 2, wherein the first wire and a winding-start portion of the second wire are disposed in a contactable manner and/or in a manner capable of relative movement.

4. The electric work machine according to claim 2, wherein a bonding agent fixes the first wire and the specified portion of the second wire.

5. The electric work machine according to claim 4, wherein the bonding agent fixes the first wire and the specified portion of the second wire to the insulator in a state such that the first wire and the specified portion of the second wire are spaced apart and do not contact each other.

6. The electric work machine according to claim 4, wherein at least a portion of the bonding agent is disposed between the first wire and the specified portion of the second wire.

7. The electric work machine according to claim 4, wherein the bonding agent is curable with ultraviolet light.

8. The electric work machine according to claim 2, further comprising an intermediate insulative member disposed between and spacing apart the first wire and the specified portion of the second wire.

9. The electric work machine according to claim 8, wherein the intermediate insulative member is fixed to the insulator.

10. The electric work machine according to claim 8, wherein the intermediate insulative member is formed of rubber or synthetic resin.

11. The electric work machine according to claim 2, wherein the insulator has at least one first support surface, which supports the first wire, and at least one second support surface, which supports the second wire in a state such that the first wire and the specified portion of the second wire are spaced apart and do not contact each other.

12. The electric work machine according to claim 11, wherein the at least one first support surface and the at least one second support surface are disposed at different locations in an axial direction of the stator.

13. The electric work machine according to claim 12, wherein the at least one first support surface and the at least one second support surface are disposed at different locations in a radial direction of the stator.

14. The electric work machine according to claim 11, wherein:
the insulator has a plurality of the first support surfaces and a plurality of the second support surfaces,
the first support surfaces and the second support surfaces are disposed at different locations in an axial direction of the stator and are disposed at different locations in a radial direction of the stator;
the first support surfaces are disposed spaced apart in the circumferential direction;
the second support surfaces are disposed spaced apart in the circumferential direction;
the first support surfaces and the second support surfaces are disposed such that they do not overlap within a plane that is orthogonal to a rotational axis of the motor.

15. The electric work machine according to claim 1, wherein:
the insulator comprises first and second guide rib;
a winding-end portion of the second wire includes a winding-end portion in a first state in which it is disposed such that it covers the first wire, and a winding-end portion in a second state in which it is disposed such that it is covered by the first wire;
the first guide rib supports the winding-end portion in the first state, and the second guide rib supports the winding-end portion in the second state;
in the circumferential direction of the stator, the first guide rib has a pair of end parts, and the second guide rib has a pair of end parts; and
in the circumferential direction of the stator, a first distance between the winding-end portion in the first state and one of the pair of end parts of the first guide rib that is near the winding-end portion in the first state is longer than a second distance between the winding-end portion in the second state and one of the pair of end parts of the second guide rib that is near the winding-end portion in the second state.

16. The electric work machine according to claim 1, further comprising:
a fusing terminal electrically connected to one of the coils via the first wire and the second wire;
wherein:
the motor comprises a terminal-unit main body connected to the insulator;
the fusing terminal is disposed on a fusing-terminal retaining part of the insulator in a state such that the fusing terminal is supported by the terminal-unit main body; and
one of:
the fusing terminal, the first wire, the second wire, the fusing-terminal retaining part, and the terminal-unit main body are fixed by a bonding agent; or
the first wire, the second wire, and the fusing-terminal retaining part are fixed by the bonding agent; or
the first wire, the second wire, the fusing-terminal retaining part, and the terminal-unit main body are fixed by the bonding agent.

17. An electric motor comprising:
a stator having a stator core with a plurality of teeth;
an insulator fixedly coupled to the stator core;
a plurality of coils respectively wound on the insulator and on the plurality of teeth;
a first wire or wire segment that electrically connects a first pair of the coils;
a second wire or wire segment that electrically connects a second pair of the coils; and
a rotor disposed within the stator core and being rotatable relative to the stator core;
wherein:
at least a portion of the first wire or wire segment extends adjacent to at least a portion of the second wire or wire segment within a circumferential range of the stator; and
in at least a portion of said circumferential range, one of:
an intervening structure is interposed between the first wire or wire segment and the second wire or wire segment so that the first wire or wire segment and the second wire or wire segment do not contact each other; and/or
a bonding agent fixes the first wire or wire segment relative to the second wire or wire segment so that the first wire or wire segment and the second wire or wire segment are immovable relative to each other.
